(19) United States
(12) Patent Application Publication
(10) Pub. No.: US 2005/0278186 A1
(43) Pub. Date: Dec. 15, 2005

(54) Word puzzle assembly and methods related thereto

(76) Inventor: Carlos de la Huerga, Milwaukee, WI (US)

Correspondence Address: QUARLES & BRADY LLP, 411 E. WISCONSIN AVENUE, SUITE 2040, MILWAUKEE, WI, 53202-4497, US

(21) Appl. No.: 10/935,804

(22) Filed: Sep. 8, 2004

Related U.S. Application Data
(63) Continuation-in-part of application No. 10/868,059, filed on Jun. 15, 2004.

(51) Int. Cl. G06F 17/60

(52) U.S. Cl. 705/1; 705/14

(57) ABSTRACT

A method for selling novelty items, the method including the steps of providing an apparatus including a retainer and an input device, the retainer for concealing at least one of a message and an item until a specified word that is specified via the input device matches an answer word, providing a first card including a word puzzle that can be answered with the answer word, and presenting the card and apparatus together as a set for sale.

### CROSS-REFERENCE TO RELATED APPLICATIONS

This application is a continuation-in-part of U.S. patent application Ser. No. 10,868,059 filed Jun. 15, 2004, and entitled “Word Puzzle Assembly And Methods Related Thereto”.

### STATEMENT REGARDING FEDERALLY SPONSORED RESEARCH OR DEVELOPMENT

Not applicable.

### BACKGROUND OF THE INVENTION

This invention relates generally to locking compartments and more specifically to an assembly that includes a compartment that is concealed when a key member is received within rotatable tumblers and related methods.

This section of this document is intended to introduce various aspects of art that may be related to various aspects of the present invention described and/or claimed below. This section provides background information to facilitate a better understanding of the various aspects of the present invention. It should be understood that the statements in this section of this document are to be read in this light, and not as admissions of prior art.

A recent book by Author Dan Brown, “The DaVinci Code” (hereinafter “the book”), has generated a renewed interest in mysteries and word puzzles. Featured in the book is a contraption referred to as a DaVinci Cryptex (hereinafter “the Cryptex”). As described, the Cryptex is a cylindrical assembly that is generally small enough to be manipulated within a person's hands and includes multiple rotating sections and a “key” that is removably receivable within the rotating sections. The exterior of each Cryptex section has the alphabet inscribed around its perimeter. Characters in the book are presented with a mystery/puzzle, the solution of which is a single word answer, presumably of a character length equal to the number of rotating sections in the Cryptex. The sections can be rotated so as to spell the correct word answer to the puzzle after which the key is removable from the lock which reveals the text of a new puzzle written on papyrus.

As the story in the book progresses, the characters go on an elaborate journey in search for clues regarding the correct answer word and, over time, ascertain the correct word which enables removal of the key. In the book, one of the Cryptex components forms a compartment in which an item (e.g., a second smaller Cryptex, a note, an item, etc.) can be concealed until the key is removed. In the book a message is written on a sheet of papyrus that is placed within the compartment.

In addition to the components above, the Cryptex in the book includes a glass vial of vinegar presumably within compartment that is designed and positioned with respect to the other Cryptex components to break if the Cryptex is forced open prior to the tumblers being aligned to spell the correct word answer. Vinegar apparently destroys papyrus and hence would destroy the message printed on the papyrus if spilled thereon. Thus, the characters in the book, in effect, get only one chance to open the Cryptex correctly.

While a Cryptex is an interesting contraption, the Cryptex described in the book has several shortcomings as a product for mainstream mystery and puzzle use. First, for a Cryptex like the one described in the book, the Cryptex is specifically designed for a single correct answer word and the Cryptex cannot be reused with other puzzles and associated answer words. A Cryptex that has only a single correct answer word can only be effectively used a single time with a specific person-once the answer word is determined by a person, the word is known and opening the Cryptex is no longer an interesting challenge.

Second, where separate Cryptex have only a single answer word, the cost of manufacturing the unique Cryptex would be relatively expensive. To this end, where there are 1000 separate puzzles and associated answers, 1000 differently configured Cryptex would have to be designed and manufactured—a costly proposition.

Third, as with most products that can only be effectively used once, where a Cryptex has only a single answer word, a maximum purchase price for most purchasers will typically be low. A low purchase price combined with the costs of manufacturing many different Cryptex configurations (i.e., a separate configuration for each puzzle and associated answer word) would make it difficult at best to make a profit in the Cryptex business.

Fourth, while the concept of destroying a message or item inside a Cryptex if the Cryptex is opened prior to spelling the correct answer word via the Cryptex tumblers is intriguing, using a breakable glass vinegar vial or the like is a messy and potentially dangerous solution which would not be acceptable to many potential purchasers.

Fifth, one of the interesting things about the journey to find clues to the correct word answer in the book is that an elaborate and automatically unfolding scheme is set up to yield the clues over time. In the book, the scheme generally involves activities independent of the Cryptex. While it would be extremely difficult to set up a scheme as elaborate as the one in the book, it would be advantageous if answer clues could be automatically presented over the course of a predetermined period thereby simulating a journey akin to the journey that occurs in the book. The Cryptex in the book is incapable of simulating a journey alone.

Sixth, in many cases a Cryptex user may want to come up with her own puzzle and answer word that may have a special meaning to the user and a person that receives the Cryptex. Here, where Cryptex are configured for use with a single answer word, personalized puzzles and answer words usually would not be supported.

Seventh, Cryptex like the one in the book require at least two people to be useful, a first person to design the mystery, craft the puzzle and the answer word and configure the Cryptex and a second person to receive the Cryptex and the puzzle and to solve the puzzle to reveal the contents of the compartment. In at least some cases it would be advantageous to have a system whereby a single person could use a Cryptex to play a mystery game.

Locking mechanisms have been designed for luggage and the like that include tumblers and a locking key received therein where the key is only removable when the tumblers are aligned in a specific orientation (e.g., so that a numeric code is aligned along an axis perpendicular to the tumblers). Here, in some cases, the mechanisms are designed so that the codes can be altered in some fashion. For instance, an exemplary locking mechanism includes a spring loaded configuration wherein, when the tumblers are in the unlocked position, a spring loaded member can be slid into a code setting position, the tumblers can be rotated until a new desired code is aligned and the spring loaded member can then be released.

While luggage type locking mechanisms are useful for locking luggage compartments or the like, luggage type locking mechanisms do not include a separate compartment that is concealed when the key is received within the tumblers and therefore are not suitable for use as a Cryptex. In addition, while a message or item could be placed inside a luggage compartment and locked therein via a luggage type lock, the resulting configuration and operation would not have the same appeal as a self contained Cryptex that can be held and manipulated in a users hands. Moreover, while codes can be altered in the case of some luggage type locking mechanisms, the length of the code cannot be altered in any known luggage type locking mechanism so that, even if . Furthermore, while spring type mechanisms have been designed for luggage locking mechanisms to modify codes, it is unclear how such mechanisms would be configured for use with a Cryptex that includes a concealed compartment.

Therefore it would be advantageous to have a Cryptex that can be used with more than a single puzzle and associated answer word. In addition, it would be advantageous to have a Cryptex wherein the answer word could be modified relatively easily and where a single person, in at least some cases, could use the Cryptex to play a puzzle game. Moreover, it would be advantageous to have a system wherein clues could be periodically provided to a Cryptex user thereby simulating a journey in search of clues.

### BRIEF SUMMARY OF THE INVENTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

It has been recognized that a Cryptex type assembly can be configured that includes both a retainer for a message or an item and a tumbler assembly where the tumblers can be manipulated to alter a correct answer word that enables a key to be removed from the tumblers. Thus, a Cryptex like assembly can be provided that can be used multiple times and with many different word puzzles.

It has also been recognized that an electronic Cryptex type assembly can be provided that includes a processor and a small display screen (e.g., LCD display, other flat panel technology, etc.) wherein a message may be displayed via the screen when the key is removed. In this case, the message stored for presentation via the display screen may be easily altered and, in at least some cases, could be modified over time.

In some embodiments of the present invention an exemplary Cryptex is a linear combination lock that is generally opaque or translucent so that its inner workings are not visible. The lock may include multiple rotating sections or tumblers with a fixed linear key that has a series of projecting pins along its length. Each tumbler may include a series of markings (e.g. the 26 characters of the alphabet or 10 digits) on the exterior wall(s) and a central hole through which the key passes to be locked in or removed when unlocked. In some cases the tumblers also have an enlarged countersunk hole or recess centered over the main hole. Here, the tumblers are sized in height to match the spacing of the pins in the key and the counter sunk holes are sized so that the tumblers can rotate freely around the projecting pins of the key. The tumblers may be in a cylindrical form, but other sectional shapes can be used as desired.

Each tumbler may also have a keyway cut radially from the center hole through to the countersunk hole. The keyways are sized to allow the projecting pins of the key to pass through the tumbler when properly aligned. In this manner when the tumblers are arranged according to a combination by orienting the markers in a pattern against a fixed alignment marker, the keyways are then all aligned in a row. The projecting pins of the key pass thru all of the keyways and the key is easily removed from the lock.

Besides having the rotating tumblers, in at least some embodiments the lock includes fixed top and bottom sections where one of the sections includes an alignment marker. The top and bottom sections are secured together so that when the key is in the lock and the lock is locked, the tumblers interfere with the key and the key cannot be removed from the lock. This can be done using external posts between the top and bottom sections or any of a variety of other fastening or joining methods. When posts are used, they can be glued, attached with threads and matching nuts (e.g. with tamper resistant or locking nuts), welded, or riveted to the top and bottom.

The top section may have a hole cut in it and a keyway (if the hole is not sized so the projecting pins can pass thru it) so the key can pass through it. The bottom section may generally be solid, although it can have a countersunk hole to prevent the key from moving laterally. In some embodiments, when the key is inserted into the hole, the key is restrained by a pin, flange, or gear teeth from rotating, so that the key maintains a fixed position relative to the lock.

In some cases the tumbler only has the center hole and the cut keyway, but not the countersunk hole for the pins of the lock. Instead a fixed spacing washer can be inserted between tumblers, the washer having a central hole sized to allow the key to be inserted and removed or to have a central hole and keyway positioned to align with the key and its projecting pins.

In some embodiments the key is designed so that it has a head that extends over the center hole and the keyway in the top section of the lock. The head prevents a user from sighting down the inside of the lock to crack its combination by looking for the keyways. In some cases the key head is sized so that it covers over any nuts or fasteners used with the posts to connect the top and bottom parts of the lock, providing protection against tampering with the nuts to open the lock.

To assist with aligning the tumbler sections, a ratchet or detente mechanism may be provided so that the external markings are easy to maintain in a chosen position and do not rotate spontaneously. One design for a ratchet mechanism is to provide small recesses or dimples spaced on the top of each tumbler according to the number and spacing of the external markings of the tumbler. The bottom surface of each tumbler forms one or more rounded bumps that extend outwardly. When stacked together the bump(s) of one tumbler naturally rest in one of the dimples of an adjacent tumbler. Just enough space is provided between the assembled tumblers so that when one tumbler is rotated its projecting tip(s) or bump(s) rise out of one dimple and naturally drop into the next dimple after partial rotation.

In some cases it is desirable that the pattern of letters that opens the lock be adjusted to another pattern (word). To do this, in a t least some cases, the lock is taken apart so the individual tumblers can be removed and separated from each other. To allow a user to change which letter on each tumbler is aligned with the keyway when the tumblers are in the unlocked orientation, the tumbler is composed of two pieces, an outer one and an inner one. The inner and outer pieces can be separated and the inner one rotated so the keyway is positioned to align with a new external letter or marking. The inner and outer pieces are then pressed together. To keep the two pieces properly oriented the inner and outer pieces may be in the shape or a regular polygon with the number of side equal to the number of markings on the perimeter of the outer piece of the tumbler. Alternately a series of matching gear teeth (the number of which equals the number of external markings) can be cut in the inner and outer pieces so they mesh together. Other positioning methods are anticipated, such as pins or one of the pieces can have a partial gear teeth cut into it, but not limited to these.

To secure the inner and outer sections together one of the sections may be undercut or have a ridge to keep the two sections together.

In some cases, it may be desirable to construct a Cryptex from highly valued materials such as wood, stone or metal. The machining of complex surfaces in such materials can be cost prohibitive. A tumbler composed of three pieces would allow changing letters on tumblers without requiring complex machining on the outer, visible portion of the tumbler. The previously mentioned inner and outer rings would become the inner and middle rings of a three ring arrangement. The inner and middle rings would operate as previously described. The outer ring can have a round, easily machined hole through its center, into which the outside of the middle ring is fit via any of a number of fastening techniques (e.g. pressure, adhesive). The combination of middle and outer rings then perform as the outer ring in the previous description.

When the Cryptex has provision for a seven letter word (forming a seven letter combination), but the word chosen to unlock it only has five letters, the lock is taken apart and the bottom two tumblers can be pinned together and to a non-rotating lock bottom section. In this example, the two bottom tumblers are aligned so that their keyways allow the key to be removed without further action. Preferably, when so aligned, the external markings include a space or blank “marking” that is aligned with the alignment marker on the top section or bottom section In this way a person using the Cryptex will know that the bottom two tumblers are not used.

Another method to accommodate shorter words is to assemble the lock with only 5 tumblers and to adjust the length of the linear key. One method of adjustment is to cut the key to the proper length, however this is not desirable as the key could not thereafter be used with longer words. Instead the key may be made in segments equal in length to the height of one of the tumblers. By removing two sections a key for 7 tumblers can be adjusted to fit a lock of five tumblers. Any method of adjusting the key length must ensure the key does not come apart when in or being removed from the lock and that the key or any section of it does not rotate in the lock.

Another Cryptex type embodiment includes a secret message associated with a key and incorporates the feature of allowing the key to be withdrawn when the tumblers are in any position. The secret message may be presented in this case on a display screen or the like when displayed. In this case, if the tumblers are not properly aligned to define the correct answer word when the key is removed, the secret message may be erased. Here, when the tumblers are properly aligned, the key is removable to reveal the secret message via the display.

In some electronic versions of Cryptex type assemblies the key may not have pins along its length. Instead the key may have an internal space to accommodate a circuit board including a processor, memory, power source, indicator, timer, a variety of sensors, and a communication port. Here, the memory of the key may be programmed with an external computer or PDA device with a message that is to be presented to the user via the indicator (e.g. a LCD display or a speaker) when the key is removed from the unlocked lock.

The tumblers in this embodiment may be arranged as before without the need for the countersunk holes. Instead the tumblers each may have an electrically conductive lead that passes through from the top to the bottom of the tumbler, e.g., from one ratchet dimple to the rounded projection below. The top and bottom sections of the lock have electrical contacts that are oriented to make contact with matching contacts on the key when the key is fully inserted. The top contact is connected to one of the ratchet rounded bumps for the top section and the bottom section contact is connected to one of its ratchet dimples. While the use of the ratchet mechanism is described, other provisions or areas for conducting electricity through the top and bottom sections and tumblers are anticipated.

When the tumblers are aligned so that the external markings match the pattern to unlock the lock a conductive pathway is established between the top section contact and the bottom section contact through every tumbler. The key has matching electrical contacts between the processor and the top and bottom section contacts. The processor may detect the presence of this conductive pathway and set an unlocked flag. The key also has a sensor to determine that it has been removed from the lock, for example using another set of electrical contacts, a switch, a photocell, etc. When the key is removed and the unlocked flag is set, the key may present the secret message via the display screen.

In the example here, whenever the tumblers are not properly aligned, the processor unsets the unlocked flag. If the key is removed while the flag is unset, the processor detecting the removal via its sensor for this purpose will not present the secret message via the indicator. Instead no message can be presented or one that indicates that the wrong word or pattern of markings was used when removing the key may be presented. If desired the key can also indicate that the key will become inert for a period time that the processor uses the timer to measure. The key can be reinserted in the lock, but the key will not respond and present any message other than a period of time that must pass before the next key removal will be confirmed (e.g. a day). In this manner, several tries can be made to guess the alignment pattern of the tumblers, but consecutive attempts are separated by periods. Using this design the user cannot determine what the correct alignment of the tumblers must be because the electrical contacts on the tumblers are hidden from view.

A sensor may be used by the key to determine if the lock is being disassembled. Upon detecting of this condition the processor can erase the secret code so that it will never be displayed.

If desired the key with projecting pins can also be used with the electronic lock, but in this case the key can only be removed when the tumblers have been properly oriented to unlock the lock. In this case the removal sensor is no longer needed, but the lock disassembly sensor can be used.

To prevent the key from being inadvertently removed from the lock before the tumblers are aligned as desired, a latch, spring, or interference ridge may be used. Here, to remove the key a user must press in the latch or spring thereby de-latching the key for removal.

In some cases it is desirable to purchase the Cryptex with a preprogrammed word as the alignment pattern for the tumblers. It is anticipated that the purchaser will select a Cryptex at a store or via the Internet with a preprogrammed answer word and an accompanying word puzzle, mystery, rhyme, or phrase whose solution or conclusion is the preprogrammed answer word. Typically the word puzzle is printed as part of a greeting card format that is given to the recipient of the Cryptex without the preprogrammed answer word printed on the card. The greeting card can be customized to include another message such as “Happy Birthday” or “Congratulation on Graduating”. Inside the Cryptex can be a second secret message, for example a location where a present can be found. The recipient then guesses the correct word or order of the external markings to open the Cryptex.

If the recipient fails to guess the correct word the person giving the Cryptex can provide other hints. To that end a Cryptex with a very challenging word may include more than one card so additional hints can be provided. Otherwise the original card can include an Internet web address where additional hints for this specific Cryptex are provided, for example a new hint every day or 8 hours.

In the case of an assembly where the unlocked position of the tumblers can be changed, suitable greeting cards with word puzzles and matching solution or answer words can be sold. In at least some cases it is contemplated that the answer word may be provided separate from the card. The purchaser of the assembly can buy the card, program the word into the assembly and give the assembly and the card with the word puzzle to a recipient to unlock.

Alternately, the owner of the Cryptex can review a list of puzzle questions on the Internet and purchase a greeting card with that question for download over the Internet (e.g. in a universal high quality image format such as the PDF format) to be printed on their printer. Additionally the text of the greeting card can be customized for the person to receive the Cryptex with their name or additional greeting message. The answer to the question is then provided for the purchaser/giver to retain. It may be desirable in this type of commerce that the puzzle question and the answer are not provided at the same time until a purchase has been made, otherwise the owner of the Cryptex may print the question and the answer without payment.

In some cases an answer word may be proved and the user may select a difficulty level for the puzzle question. When a purchase is made the puzzle question can be sent to over the Internet in a greeting card format that can be customize by the purchaser.

In other cases the Internet can be used to purchase a Cryptex where the puzzle question and answer is either specified and entered by the purchaser or selected from previously created questions and answers. The purchaser is then shipped an assembled Cryptex that is unlocked using the specified answer, a matching greeting card, and the answer on a separate piece of paper for retention. If desired the answer can be retained on the Internet site providing the Cryptex.

In at least some cases an external display screen or an audio output mechanism may be provided on at least one of the assembly components for providing periodic clues to an assembly user regarding the correct answer word. In addition, in at lest some cases, the external display screen may be used to provide the message when the key is successfully removed from the tumblers.

In some embodiments it is contemplated that a USB or a wireless system may be used to transmit new answer words to electronic Cryptex type assemblies wherein assembly processors could then modify the correct answer words associated therewith. Thereafter, a puzzle could be e-mailed or otherwise provided to a user of the assembly so that the user could play a word game independent of other users.

In at least some cases the step of providing the apparatus includes receiving a designation of the contents of the retainer and providing the designated contents in the retainer. In some cases the step of providing the apparatus includes the steps of providing a cost for providing the apparatus and receiving a payment prior to providing the apparatus.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE SEVERAL VIEWS OF THE DRAWINGS

The invention will hereafter be described with reference to the accompanying drawings, wherein like reference numerals denote like elements, and:

FIG. 1 is a perspective view of a first embodiment of a Cryptex type assembly in its locked state, a word puzzle associated with the assembly and an answer to the word puzzle;

FIG. 2 is a perspective view of the assembly of FIG. 1 in an unlocked state showing a key removed from the lock;

FIG. 3 is a perspective view illustrating one of the tumblers of FIG. 1;

FIG. 4 is a second perspective view illustrating the tumbler of FIG. 3;

FIG. 5 is a sectional view taken along the line 5-5 of FIG. 1;

FIG. 6 is a sectional view similar to FIG. 5, albeit with the assembly in an unlocked state showing the key removed;

FIG. 7 is an exploded sectional view of an alternate embodiment of a tumbler composed of inner and outer pieces that can be rotationally rearranged to assume several different positions when placed together and taken along the line 7-7 in FIG. 9;

FIG. 8 is similar to FIG. 7, albeit illustrating the inner and outer pieces in a mating orientation;

FIG. 9 is a plan view of the tumbler of FIG. 8 with the tumbler in a first orientation;

FIG. 10 is similar to FIG. 9, albeit with the inner piece in a different orientation with respect to the outer tumbler piece;

FIG. 11 is similar to FIG. 7, albeit illustrating another two piece tumbler subassembly and taken along the line 11-11 in FIG. 12;

FIG. 12 is similar to FIG. 9, albeit illustrating the tumbler of FIG. 11;

FIG. 13 is a cross sectional view of a tumbler with replaceable markings on a separate strip taken along the line 13-13 in FIG. 14;

FIG. 14 is a perspective view of the tumbler of FIG. 13;

FIG. 15 is a plan view of a separate strip of replaceable markings;

FIG. 16 is a perspective view of another embodiment of a Cryptex type assembly that includes spacers between tumblers;

FIG. 17 is a cross sectional view taken along the line 17-17 of FIG. 16;

FIG. 18 is a cross sectional view of the key of FIG. 17 showing that the key can be split into different key lengths;

FIG. 19 is a cross sectional view similar to FIG. 17, albeit of a third embodiment of a Cryptex type assembly including an electronic key;

FIG. 20 is similar to FIG. 19, albeit with the key removed from the other assembly components;

FIG. 21 is a cross sectional view of a tumbler and key wherein the tumbler includes multiple position sensors;

FIG. 22 is a schematic view of circuitry associated with the third embodiment in FIG. 19;

FIG. 23 is a perspective view of a gift set including a Cryptex, greeting card and an answer card along with a box used to market the set;

FIG. 24 is a computer screen view of illustrating an Internet purchase of a Cryptex based greeting card;

FIG. 25 is a computer screen shot illustrating a step performed to print a word puzzle in a greeting card format via the Internet or the like;

FIG. 26 is a perspective view of an alternate embodiment of a Cryptex type key shaft;

FIG. 27 is a cross sectional view similar to FIG. 5, albeit including the key of FIG. 26 and differently configured tumblers;

FIG. 28 is a side view of exemplary tumblers made from a grained material;

FIG. 29 is a side view of the tumblers of FIG. 28 rotated to an unlocked alignment;

FIGS. 30A and 30B are flowcharts representing process used to package and offer to sell a Cryptex with greeting card with a word puzzle and an answer word;

FIG. 31 is a flowchart showing the steps to purchase a Cryptex that can be modified to select new answer word;

FIG. 32 is a flowchart is the steps to purchase a Cryptex that can be modified to select new answer word;

FIG. 33 is a flowchart showing the steps to purchase a Cryptex that is purchased without a word puzzle; and

FIGS. 34A and 34B are schematic flowcharts showing the steps to select and purchase a word puzzle and word answer.

### DETAILED DESCRIPTION OF THE INVENTION

One or more specific embodiments of the present invention will be described below. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

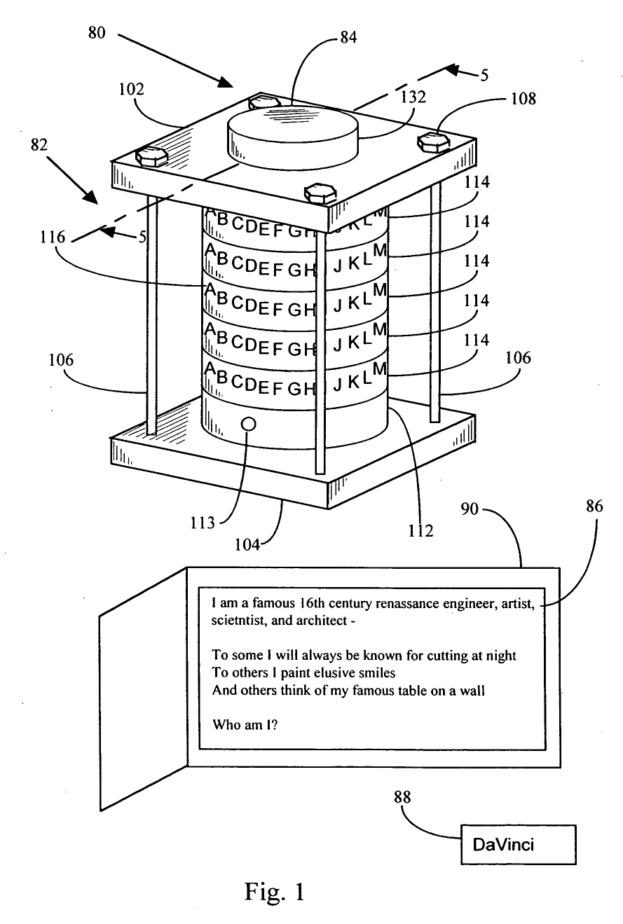

The present invention relates to the construction, programming and purchase of a Cryptex type assembly 80 (see FIG. 1 and others) referred to hereinafter in the interest of simplifying this explanation as a Cryptex. Cryptex 80 is a lock assembly having an unlocking secret word, phrase or answer word 88 that is the solution or match to a word puzzle, mystery, rhyme, or phrase 86 (see FIG. 25). Cryptex 80 is typically given by one person to a recipient as a gift along with word puzzle 86, for example, as part of a greeting card 90. Answer word 88 is not given to the recipient. The Cryptex recipient must solve word puzzle 86 to obtain answer word 88 in order to open Cryptex 80. Answer word 88 may be any alphanumeric combination of characters or a pattern of icons in sequence. While several different word puzzles 86 and answer words 88 are shown in the figures, the invention is not limited to those examples

Cryptex 80 shown in FIG. 1 includes a lock 82 and a matching key 84. Lock 82 is comprised of a top section 102, a bottom section 104, one or more linking members or connectors 106 (two of which are labeled in FIG. 1), which may be posts, bars, struts, or a solid extension between top section 102 and bottom section 104. In some cases connector(s) 106 are secured to top section 102 and bottom section 104 with one or more mating devices 108 such as nuts, screws, bolts, rivets, etc. Mating devices 108 can be designed to be tamper proof or locking so they cannot be removed. In some cases connectors 106 can be welded (e.g. sonic or arc welding) or hammered (e.g. riveted) to top 102 and bottom 104 sections. Together, top 102 and bottom sections with connectors 106 define a tumbler retainer.

Below top section 102 is an optional spacer 110 (see FIG. 5) that is fixed to top section 102 and above bottom section 104 is an optional spacer 112 that is optionally similarly fixed to or part of bottom 104. An alignment marker 113 (or more than one marker) is placed on some portion of top section 102, bottom section 104, spacer 110, or spacer 112. The purpose of marker(s) is explained below.

Top section 102 forms a central opening 150 that is aligned with axis 300 when section 102 is stacked at one end of the tumbler stack. In addition, section 102 forms a keyway 152 that extends laterally from opening 150. A hole 157 is formed in a top surface (not labeled) of top section 102 adjacent opening 150.

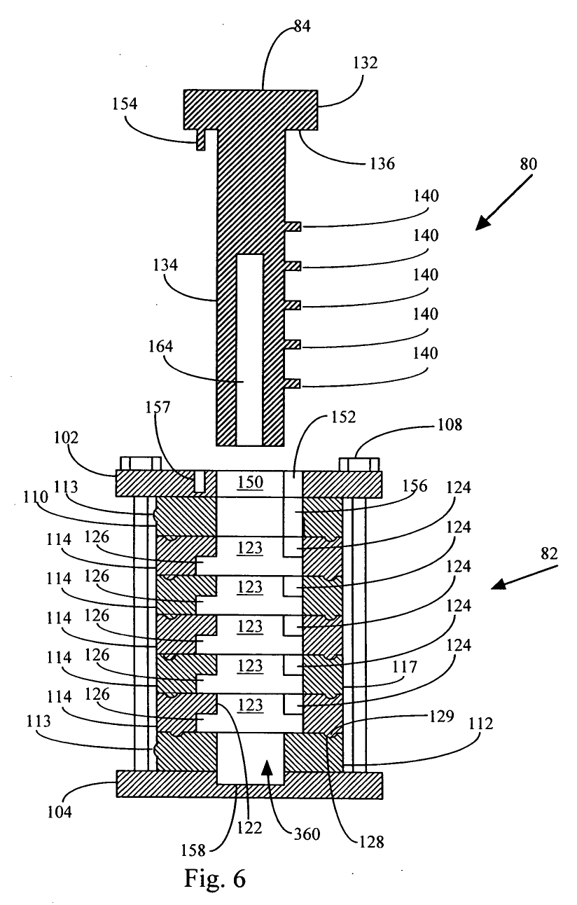

In the illustrated embodiment, each of spacers 110 and 112 form a central opening 354 and 356, respectively, and spacer 110 forms a keyway 156. Bottom section 104 forms a central countersink hole, recess or opening 158. As illustrated, when sections 102 and 104, spacers 110 and 112 and tumblers 114 are stacked together, the components form a tumbler channel 360 (see FIG. 6) about tumbler axis 350.

Between top 102 and bottom 104 sections are a series of rotating tumblers 114 which can be circular or multi-sided in plan view. Tumblers 114 are arranged in a stack about tumbler axis 350. Each of the tumblers is similarly constructed and operates in a similar fashion in at least some embodiments and therefore, unless indicated otherwise and in the interest of simplifying this explanation, only one of tumblers 114 will be described here in detail.

Referring to FIGS. 1-5, on external surface or wall 117 of tumbler 114, marks or indicia 116 are formed or printed that may include letters (including the space character) and/or numbers and/or icons. Typically, indicia 116 are uniformly spaced around external wall 117 of tumbler 114, however gaps or spaces can be provided as well. The periphery of tumbler 114 is shown as a circle, however, it may include a plurality of flat surfaces (e.g., one surface per letter/number). When characters are used, tumbler 114 need not include all 26 characters of the alphabet. Instead, each tumbler may have a smaller number of characters (e.g., 6-8).

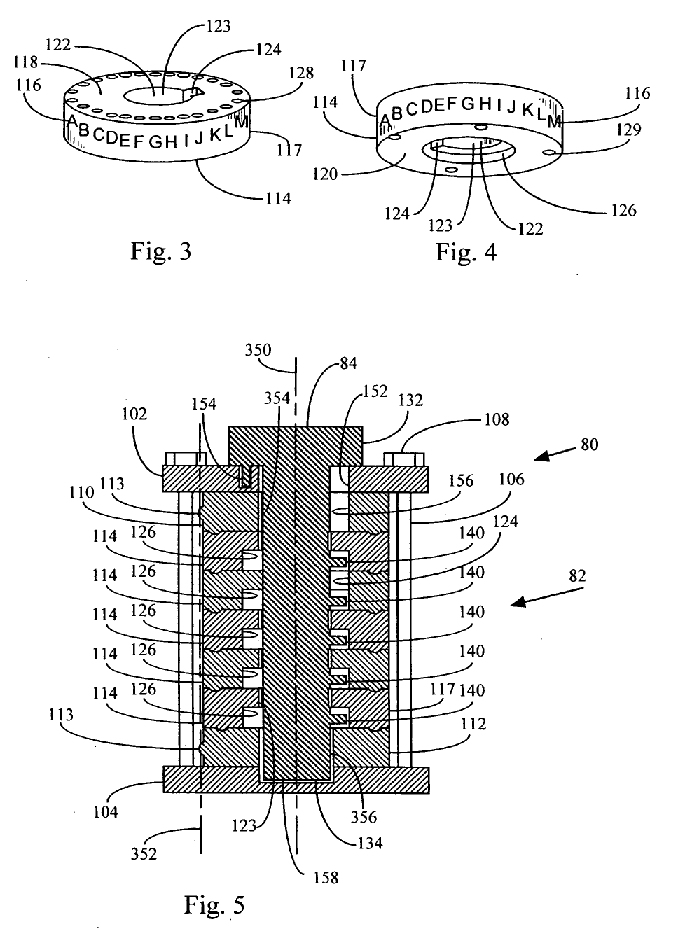

Each tumbler has a top (i.e., first) surface 118 (see FIGS. 3 and 4) and a bottom (i.e., second) surface 120. When the tumblers 114 are stacked along axis 350, the bottom surface 120 of one tumbler 114 rests on the top surface 118 of an adjacent tumbler. In addition to the external surface 117, each tumbler has an internal surface 122 that defines an opening 123 that is centered on the tumbler axis 350 when the tumblers 114 are stacked. When the tumblers 114 are stacked, alignment markers 113 define an alignment axis 352 that is parallel to the tumbler axis 350 (see FIG. 5).

Vertical keyway, recess or gap 124 extends laterally from opening 123 and stops short of external wall 117. Cut into bottom surface 120 is a countersunk hole or opening 126 that has the same center line as opening 123 and a radius generally equal to the distance from the center of tumbler 114 to the distal end of keyway or gap 124. Openings 123 and 126 come together at a ridge and form a tumbler coupler or collar where gap 124 extends through a portion of the collar.

Optionally, tumblers 114 can have a detent feature or ratchet mechanism to help an assembly user keep tumblers 114 aligned after rotation. The detent mechanism is provided such that the separate tumblers 114 rotate more readily when indicia thereon is misaligned with markers 113 than when the indicia is aligned with the markers 113. Thus, for instance, assuming six equispaced letters arranged about external surface 117, if a first letter is aligned with marker 113, initially the detent feature will impede rotation of the tumbler but, after rotation through a small angle (e.g., 5°), rotation will be relatively easy until the next adjacent letter is aligned with marker 113 (i.e., after 60° of rotation). In at least some embodiments the ratchet mechanism includes one or more dimples or recessions 128 arranged on top surface 118 so as not to interfere with keyway 124. The dimples are arranged to correspond to indicia 116, so if there are 26 markers uniformly spaced on tumbler 114 there may be 26 matching dimples. The top surface of bottom spacer 112 also includes recessions 128.

Referring to FIGS. 4 and 5, bottom surface 120 has one or more rounded bumps or raised members 129, sized to rest in recessions 128 and therefore arranged an equal distance from the center axis of the tumbler 114 as are recessions 128. The bottom of top spacer 110 similarly includes one or more matching raised members 129. Other forms of ratchet mechanisms are envisioned such as springs, brackets, and wires that are common in the prior art which may bear upon the tumblers external surface 117 or internal surface 122.

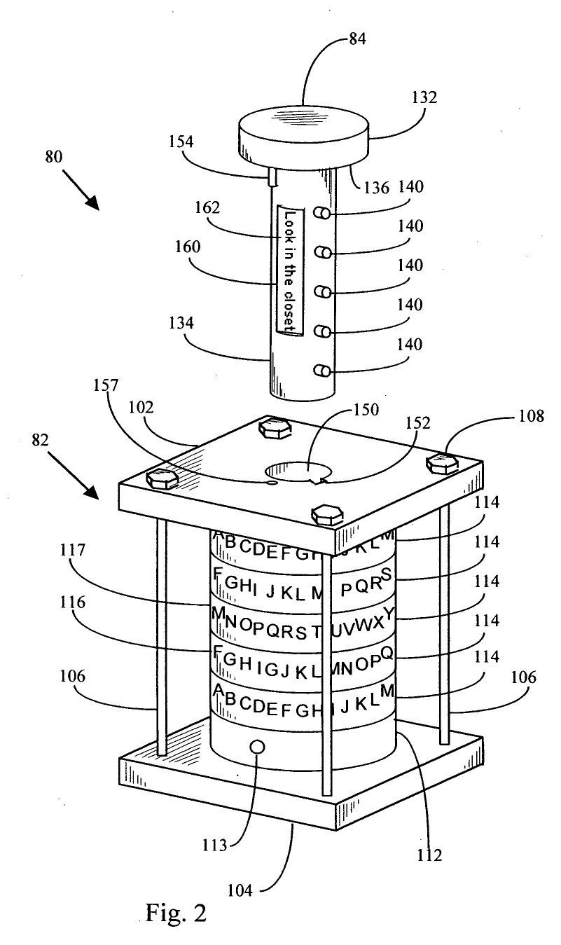

Referring to FIGS. 2, 5 and 6, linear key 84 as shown has a generally circular cross section sized to pass through opening 123 of the tumblers 114 when the tumblers are stacked. In some embodiments, key 84 may have a multi-surface (e.g., polygon) cross section. Key 84 includes a head member 132 and an elongated shaft member 134. The underside 136 of head member 132 is arranged as explained below. A series of key couplers or projecting pins 140 are spaced along the length of shaft member 134 to align with the tumbler openings 126 when the tumblers 114 are stacked and key 84 is received therein.

An alignment pin 154 extends from head member 132 in the same direction as shaft member 134 and is spaced apart from shaft 134 to be aligned with, and is sized to be received within, hole 157, when shaft member 134 is received and passes through opening 150. Pin 154 and hole 157 cooperate to restrict/prevent rotation of key 84 with respect to top section 102. Other methods of preventing key 84 from rotating are contemplated such as rotation restrictors, gear teeth, flanges, or first and second stop surfaces in lock 82 and key 84 that interact with each other to prevent rotation of key 84.

Referring to FIG. 2, in at least some embodiments, a message retainer 160 may be provided on an external surface of key shaft member 134 via which a message 162 can be provided. Here, the retainer could include a see-through plastic sleeve for receiving a small sheet of paper or, may simply be embodied in a sticker or label 160 on which message 162 is printed. In some embodiments, retainer 160 may include an electronic display such as an LCD indicator. Moreover, in some cases, retainer 160 my include a small audio speaker for, when key 84 is removed from other assembly components, broadcasting an audible message. In any event, the information retained by retainer 160, is only accessible when key 84 is removed from the assembly channel 360.

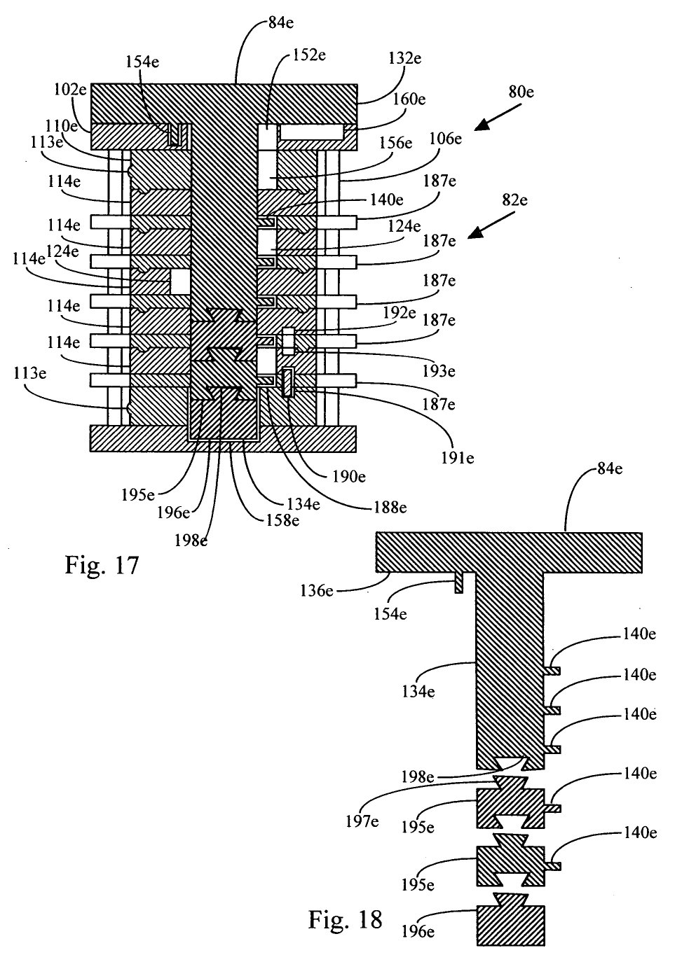

Referring to FIG. 6, in some embodiments, a retainer compartment 164 may be provided within shaft member 134. In the illustrated embodiment, compartment 164 is accessible via the distal end of member 134. In other embodiments, it is contemplated that an opening may be formed through a side surface of member 134 and a compartment door (not illustrated) may be provided to cover the compartment. Compartment 164 could be provided or formed by other assembly components such as one of the tumblers, one of the top or bottom sections 110, 112 (see 164e in FIG. 17), etc. In any event, compartment 164 is only accessible when key 84 is removed from assembly channel 360.

Shaft 134 is receivable within channel 360 so that each tumbler coupler is matched to a key coupler, forming a coupler pair. To insert key 84 into the stack, keyways 124 of each tumbler are oriented so as to be in a line so projecting pins 140 can pass through the keyways 124 and so alignment pin 154 can enter hole 157. Keyways 152 and/or 156 must also be aligned with keyways 124. To prevent key 84 from moving laterally, countersunk hole or opening 158 in bottom section 104 is provided and receives the distal end of shaft member 134. The position of the external markings or indicia 116 for each tumbler 114 relative to alignment markers 113 when the keyways are aligned corresponds to the secret code or answer word 88 that is used to unlock lock 82.

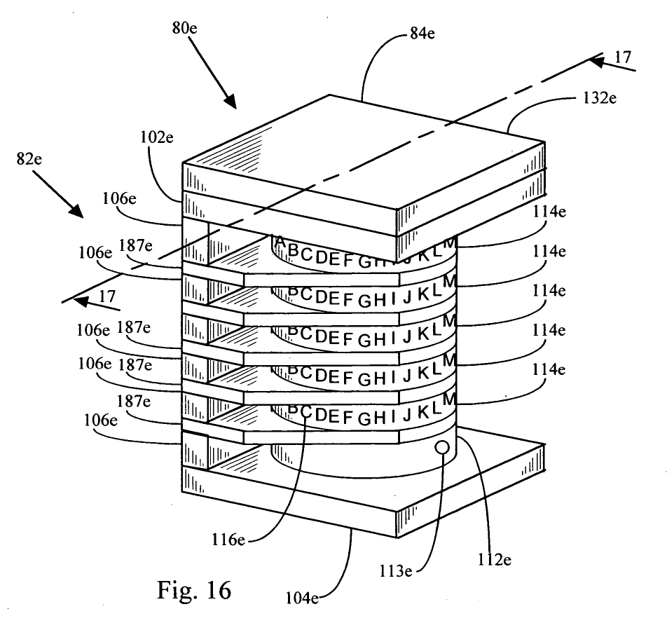

When key 84 is fully inserted, underside 136 of head member 132 completely covers opening 150 and keyway 152 so that it is not possible to peer into lock 82 to discern the positions of the keyways 124. In some cases head member 132 is arranged so as to cover any mating devices 108 (see FIGS. 16 and 17).

To lock Cryptex 80, with shaft 134 received in channel 360 one or more of the tumblers 114 are rotated. Openings 126 of each tumbler 114 are sufficiently sized that pins therein can pass when the tumbler is rotated. When locked, key 84 cannot be removed from lock 82 as one or more pins 140 are blocked by tumblers 114 whose keyways or gaps 124 are not axially aligned with associated pins. When locked, answer word 88 is not obvious to the recipient.

When Cryptex 80 is assembled and locked and when ratchet recessions 128 and raised members 129 are used, just enough room is provided between top section 102 and bottom section 104 so that one tumbler 114 at a time can be rotated with respect to adjacent tumblers. When one tumbler 114 is rotated, the recessions 128 and raised members 129 of the rotating tumbler 114 and a tumblers 114 (or top spacer 110 or bottom spacer 112) adjacent the rotating tumbler disengage until the tumbler 114 is rotated enough to allow the recessions 128 and raised members 129 to again align. Once the recessions and raised members re-align, the raised members snap or spring into the next set of recessions 128 of the adjacent tumblers 114.

When lock 82 is unlocked and key 84 is removed, the message associated with indicator or retainer 160 is accessible or provided. The secret message can be another puzzle or mystery (e.g. a puzzle that, when solved, informs the recipient of the location of a gift). However, the message may be a simple text statement and not a puzzle. In some cases a physical item, object or gift (e.g. bracelet, money, gift certificate, or candy) may be hidden inside chamber or compartment 164 (see FIG. 6) that is only accessible or visible when Cryptex 80 is unlocked and key 84 is removed from channel 360.

Alternate Cryptex Embodiment

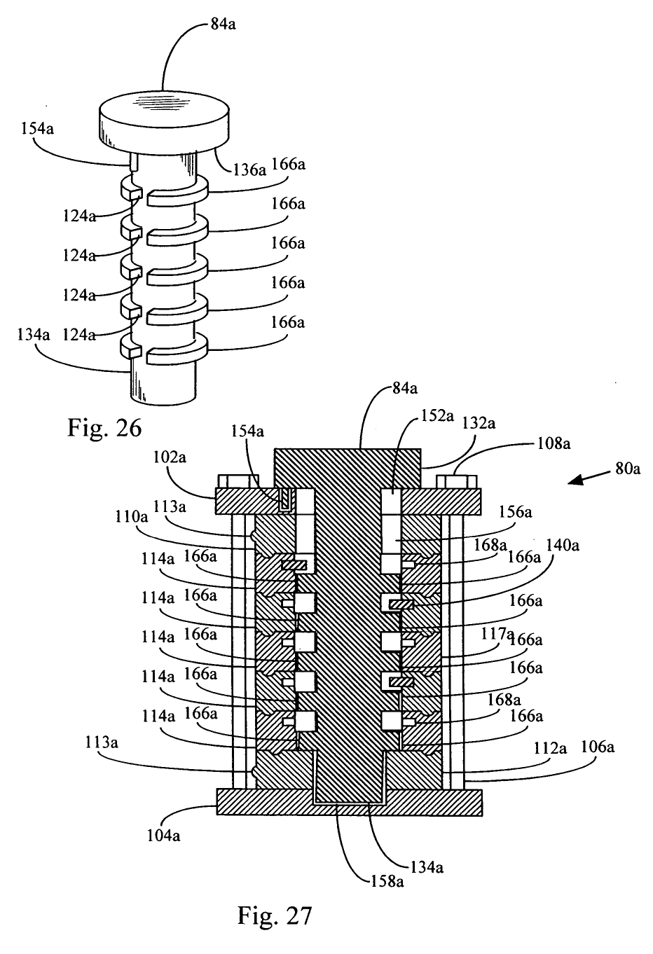

FIGS. 26 and 27 show an alternate Cryptex embodiment 80a. In FIGS. 26 and 27 components that are similar to the components described above are identified by similar numbers followed by a lower case “a”. For example, the key in FIGS. 26 and 27, is identified by label 84a. Shaft 134a of key 84a includes a series of collars 166a spaced along shaft 134a equal in number to the number of tumblers 114a. Collars 166a form key couplers. Keyways 124a re cut into collar 166a. Each tumbler has a pin 140a inserted into an opening 168a, defining a tumbler coupler. When shaft 134a is inserted into tumblers 114a through tumbler openings 126a, each pin 140a is positioned slightly above a corresponding collar 166a forming a coupler pair. By rotating any tumbler 114a, shaft 134a is retained within the tumbler channel. Thus, in the case of Cryptex 84a, pins 140a extend from tumblers 114a instead of from key 84a and collars 166a are formed by key 84a instead of by tumblers 114a.

Alternate Tumbler Design

The alignment of tumblers to unlock a Cryptex can be established and fixed when the Cryptex is manufactured. However, in some instances, it will be desirable for a purchaser of a Cryptex to be able to change the unlocking alignment of the tumblers so that the answer word 88 associated with the Cryptex can be altered. To accomplish this task, a modifiable tumbler configuration is contemplated wherein the relative juxtaposition between the tumbler coupler (e.g., the gap) and the indicia on the external surface of the tumbler is alterable.

Referring still to FIGS. 26 and 27, in at least some embodiments, two or more holes like hole 168a may be provided in each tumbler 114a for receiving pin 140a. For instance, where eight letters are provided on the external surface of each tumbler, each tumbler may form eight holes, a separate hold associated with and aligned with a separate one of the letters. Here, for example, if a current answer word is “delay” and a Cryptex user desires to change the answer word to “relay”, the user may disassemble devices 108a, remove top section 102a spacer 110a and top tumbler 114a, remove the pin 140a from the hole 168a associated with letter “d”, place pin 140a in the hole 168a associated with letter “r” and then reassemble the components thereby changing the answer word.

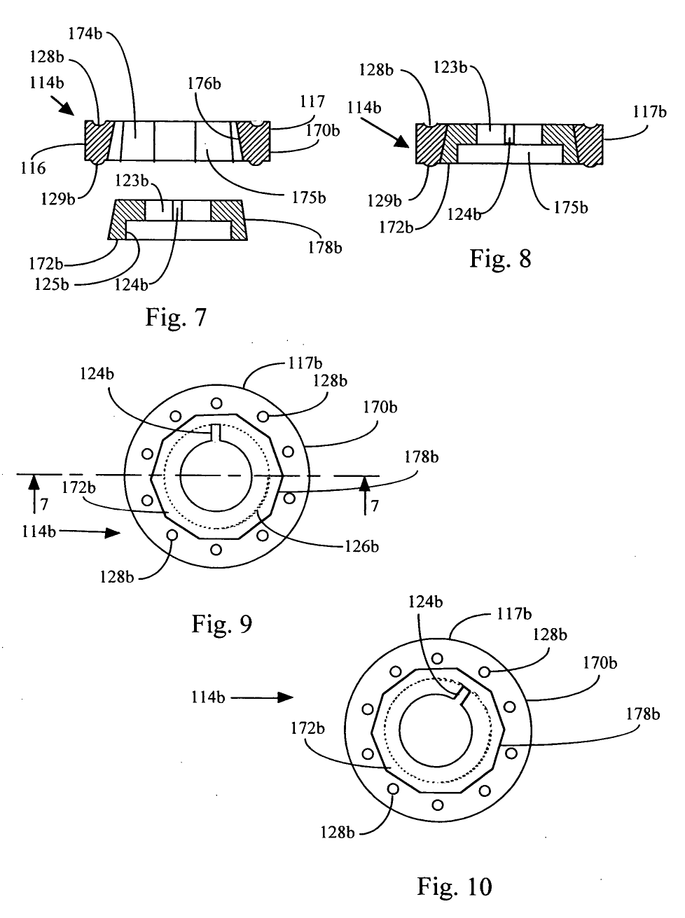

Another modifiable tumbler 114b configuration is illustrated in FIGS. 7-10. Tumbler 114b is meant to be used with other assembly components described above which will not be described again here in detail. In FIGS. 7-10, features akin to features described above are identified by similar numbers followed by a lower case “b”.

Referring to FIGS. 7-10, modifiable tumbler 14b includes an external tumbler member 170b and an internal tumbler member 172b. External member 170b forms internal surface 176b, includes top and bottom surfaces that form recesses 128b and bumps 129b and forms an external surface 117b that includes a plurality of flat surfaces that together define an opening 174b.

Internal member 172b includes an external surface 178b, an internal surface 125b and top and bottom surfaces that are not labeled. External surface 178b is shaped to mirror and to mate with internal surface 175b of external member 170b in any of several different orientations where surfaces 175b and 178b restrict rotation of member 172b with respect to member 170b in each of the different orientations. For instance, as illustrated, each of internal surface 175b and external surface 178b may include ten flat subsurfaces displaced about a central axis so that ten different relative orientations are possible. Internal surface 125b forms a collar and gap 124b akin to the similar components illustrated in FIGS. 3-6. Here, the indicia on external surface 117b is aligned with the flat surfaces that form opening 174b so that, as relative orientation of members 170b and 172b is altered, relative juxtaposition of the indicia and tumbler coupler 124b is altered. Thus, for instance, consistent with the above example, internal member 172b may be removed from external member 170b, rotated and replaced within member 170b in a second relative orientation to change a “d” to an “r” in an answer word.

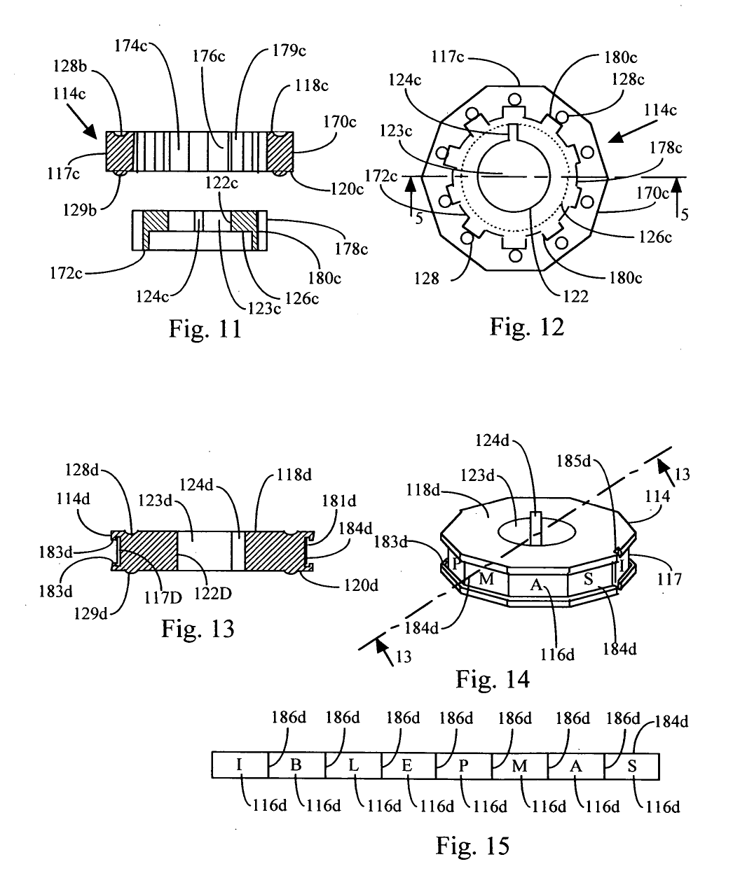

FIGS. 11 and 12 show one additional tumbler configuration that is modifiable or adjustable to change relative juxtaposition between indicia and tumbler couplers. In FIGS. 11 and 12, features similar to those described above are identified by the same number followed by a lower case “c”. In FIGS. 11 and 12, instead of forming multi-side surfaces, external tumbler member 170c has gear teeth 179c cut into internal wall 176c and internal tumbler member 172c has at least some matching gear teeth 180c cut into exterior wall 178c. The number of teeth is equal to the number of external indicia 116c and are positioned to align with indicia 116c of tumbler 114c. As above, the external tumbler member 170c and internal tumbler member 172c can be reassembled so that keyway 124c is alignable with any desired external indicia 116c.

Referring to FIGS. 13 to 15, one additional modifiable tumbler configuration 114d is illustrated where features similar to those described above are identified via the same number followed by a lower case “d”. In FIGS. 13-15, tumbler 114d includes an exterior channel 181d with overhangs 183d on the upper surface 118d and lower surface 120d into which is placed a removable marking strip 184d. Removable marking strip 184d can be inserted into channel 181d by inserting one end thereof into opening or slot 185d in overhang 183d and pushing until strip 184d generally covers external wall 117d of tumbler 114d. Slot 185d is cut in each tumbler so that slot 185d is randomly aligned with keyway 124d so that the position of keyway 124d cannot be guessed from the position of slot 185d.

Removable marking strip 184d is shown in FIG. 15 as a piece of paper printed on a conventional printer (e.g. a laser or ink jet printer). Strip 184d has indicia 116d printed in any order although they should not be duplicated. Optional fold marks 186d help position removable marker strip 184d in channel 181d. By printing removable marker strip 184d it is possible to vary the marker that is aligned with keyway 124d for each tumbler allowing any answer word to be used to unlock the lock. Other methods to alter indicia 116d on external wall 117d of tumbler 114d are contemplated (e.g., individual adhesive letters and heat shrinkable bands, etc.).

Tumblers Combined with Spacers

In at least some embodiments it is contemplated that stationary spacers may be provided between adjacent tumblers. To this end, an exemplary Cryptex configuration 80e is illustrated in FIGS. 16 and 17, where components/features similar to those described above are identified by similar numbers followed by a lower case “e”. Cryptex 80e is constructed so that tumblers 114e do not need openings 126e. Instead each tumbler 114e is separated by spacers 187 which have a thickness at least as large as the width of one of the projecting pins 140e. Spacers 187e are fixed (e.g., attached to one or more of connectors 106e or alternately to top 102e or bottom 104e). Spacers 187e also have a central hole or opening and keyway 188e aligned with opening 150 and keyway 152e of top 102e so shaft 134e can pass through the spacers when lock 82e is unlocked. Spacers 187e can also have dimples on their top surfaces and/or raised members 129e on their bottom surfaces as part of a ratchet mechanism to mate with recessions 128e and raised members 129e of tumblers 114e.

Varying Answer Word Length

In at lease some embodiments, it is contemplated that a Cryptex user may want to use a Cryptex with answer words having more than a single length (e.g., one time an answer word may include 5 characters and a following time the word may include 7 characters). Here, the present invention contemplates several mechanical solutions for altering the length or at least the effective length of an answer word. First, referring again to FIGS. 16 and 17, in at least some embodiments, it is contemplated that one or more tumblers 114e, spacers 187e and members 106e may be removed from or added to a Cryptex assembly by taking the assembly components apart and re-assembling the components in some other fashion. Here, member 106e may have alterable lengths, may include removable sections or may be swappable for other members 106e having different lengths so that variable sized stacks can be accommodated.

When the number of tumblers is altered, the key length must likewise be modified. To this end, referring to FIGS. 17 and 18, an exemplary key 84e having a modifiable length is illustrated. In FIGS. 17 and 18, shaft 134e has a relatively short length (e.g., long enough for a lock 82e of three tumblers 114e). Additional shaft members or segments 195e, each with a pin 140e, can be added to member 134e to increase the combined length. Optionally, an end piece 196e can be added to complete shaft 134e. In this manner, the total length of shaft 134e can be adjusted to accommodate as many tumblers as desired. As indicated above, connectors 106e must similarly be adjusted for length as well. For example, connectors 106e may be composed of separate segments that screw together so that length is adjustable.

Second, in some embodiments, end tumblers may be lockable so that they do not rotate about the tumbler axis, thereby reducing the effective length of the answer word. To this end, referring again to FIGS. 16 and 17, in at least some embodiments, a hole 191e may be formed in one or more of the spacers 187e for receiving a locking pin or restraining mechanism 190e. Here, a similar hole 193e is formed in each tumbler adjacent one of the spacers 187e that forms a hole 191e. The holes 191e and 193e are provided such that when a pin 190e is received in both, the pin 190e restrains movement of the tumbler and so that a blank space is aligned with alignment markers 113e. Thus, to reduce answer word length by one character, one pin 190e may be used to restrain rotation of one tumbler 114e.

Shaft segments 195e and end piece 196e must be connected to each other so they do not separate due to twisting or when key 84e is pulled or pushed. One method of connecting segments 195e and end piece 196e together is to place a horizontal male dovetail at the top of each segment that mates with a horizontal female dovetail in shaft 134e or an adjacent segment 195e. Other methods of attaching segment 195e and shaft 134e are anticipated such as screws, pins, glue, etc.

When adding or removing tumblers 14e, it may also be necessary to lengthen, shorten, or replace connectors 106e. This may be expedited when individual spacers 187e are used with individual connectors 106, so they can be added as sets for every tumbler 114e added (see FIG. 16).

Tumbler Grain Matching

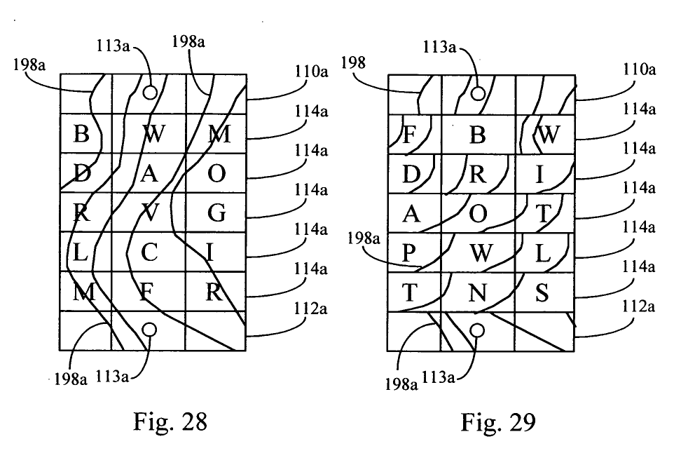

FIG. 28 shows tumblers 114a and spacers 110a, 112a that have been cut from a single piece of wood, grained stone, or variegated plastic. In this case a matching set of grain patterns 198a is visible. It is preferred that when the grain pattern 198a matches the tumblers 114a are in a locked alignment and when the tumblers 114a are in the unlocked alignment (e.g. see FIG. 29), at least some of the grain 198a patterns are not matched. Generally, most or none of the grain patterns 198a will match when tumblers 114a are in the unlocked alignment.

Electronic Embodiments

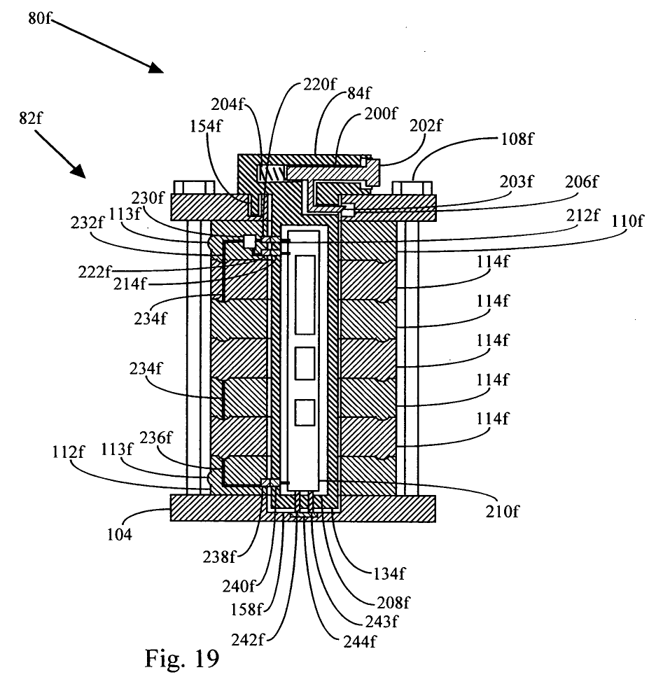

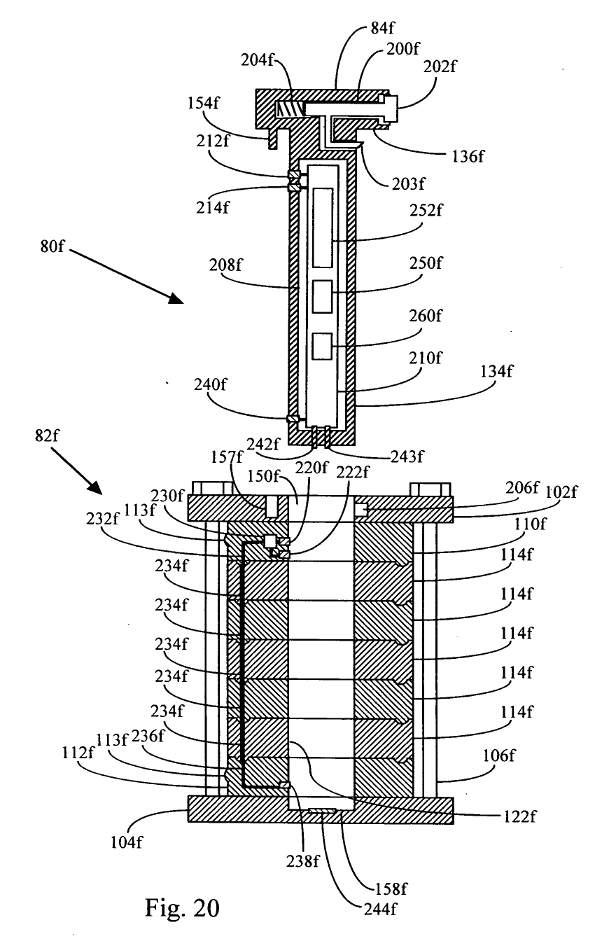

FIGS. 19 and 20 show an electronic version of a Cryptex assembly 80f where components similar to the components described above are identified by similar numbers followed by a lower case “f”.

Externally, Cryptex 80f has an appearance that is similar to the previous embodiments. To prevent accidental removal of key 84f from the channel formed by tumblers 114f, a latching mechanism 200f is provided. In one embodiment, latching mechanism 200f is part of head member 132f of key 84f and consists of a button 202f connected to a latch 203f. Button 202f and latch 203f are forcibly extended by spring 204f. When key 84f, is placed in lock 82f latch 203f is pressed into recess 206f of top section 102f. Key 84f can only be removed when button 202f is depressed to disengage latch 203f from recess 206f. Other means of securing or latching key 84f to lock 82f are anticipated including without limitation snaps, friction, bolts, screws, pins, tape, wedges, etc.

Key 84f includes an internal space 208f that houses a circuit board 210f and no longer includes pins 140. Circuit board 210f is used to arrange the electronic components show in FIG. 22 which include processor 250f and memory 251f linked to a power source 252f (e.g. battery or solar cell mounted to head member 132), a tumbler alignment sensor 256f, a key removal sensor 254f, an indicator 160f (e.g. a LCD or speaker), a timer 260f, a communication port 272f, and, when desired, a disassembly sensor 264f. Memory 251f is used to store information which may consist of an answer word(s), a word puzzle(s), hints, clues, message(s), or other data.

When key 84f is inserted into lock 82f, key removal sensor 254f detects that the key is in the lock channel. This can be done by passing a current between contacts 212f and 214f and fixed contacts 220f and 222f of top 102f or spacer 110f. When there is a closed circuit, key 84f is in the channel. Key removal sensor 254f can instead be linked to latching mechanism 200f so that it is activated when latch 203f is retracted allowing key 84f to be removed.

Tumbler alignment sensor 256f can be constructed using a fixed contact 220f which is further linked to conductor 232f that goes to one of raised members 129 of spacer 110f. Each tumbler 14f also has a single conductor 236f between one recession 128f and a raised member 129f there below. Finally, another fixed conductor 236f is placed in one dimple of bottom spacer 12f. Conductor 236f terminates at contact 238f. When key 84f is in the channel contact 240f is in electrical contact with contact 238f.

Fixed conductors 232f and 236f are aligned so that they are in a direct vertical line above each other. The conductors 234f of tumblers 114f are arranged so that when the tumblers 114f are in any locked position, the tumblers are not all making contact with each other or with conductors 232f and 236f. Only when tumblers 114f are aligned in the unlocked position is a circuit made between contacts 212f and 220f, conductor 232f, conductors 234f, conductor 236f, and contacts 238f and 240f, together acting as an alignment sensor 256f, through processor 250f.

When lock 82f is unlocked, processor 250f detects the unlocked condition and sets an electronic unlock flag. When any of the tumblers 114f are moved, processor 250f unsets the unlock flag. When key 84f is removed from lock 82f, processor 250f detects the removal and checks the unlock flag. When the flag is set, processor 250f activates indicator 160f to present a secret message. When the flag is not set, the processor 250f does not activate the indicator 160f or uses it to present a message indicating tumblers 114f were not aligned so as to unlock lock 82f. Processor 250f, in this case, may then activate timer 260f to force a time delay before another key 84f removal will result in the indicator 160f being activated. For example it may be desired after key 84f has been removed once prior to using the tumblers to indicate the correct answer word, that the user must wait for 10 minutes before the next removal will be checked to determine if lock 82f is unlocked. Key 84f removal prior to 10 minutes can result in indicator 160f presenting a message that more time must pass before unlocking will be detected. Various timing strategies are anticipated, such as lengthening or shortening the time before the next unlock attempt will be validated.

It is further anticipated that key 84f can be extended as described above where shaft segments and an end piece can be added so as to maintain the conductive path described for alignment sensor 256f (see again FIGS. 17 and 18).

In at least some embodiments it is contemplated that the secret message presented via indicator 160f may be programmed by a separate computer (e.g. a personal computer, cell phone, or PDA) that has a communication port compatible with key communication port 272f (not separately shown in FIGS. 18 and 19 but may use contacts 212f, 214f and/or 240f) such as USB or Bluetooth. Here, entering the secret message in the separate computer and communicating it to processor 250f and memory 251f will cause the processor to store the message.

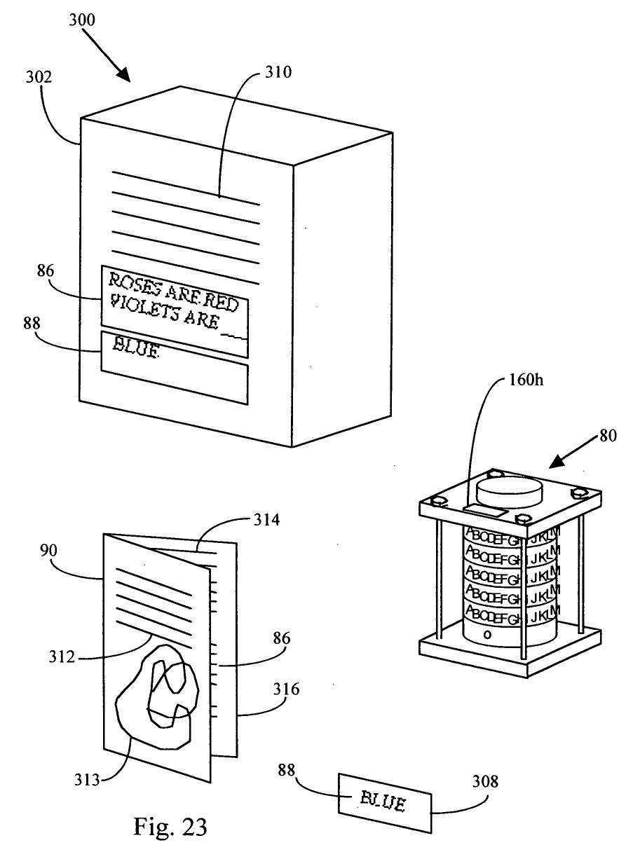

In some cases processor 250f, power source 252f, indicator 160f, and other components of circuit board 210f may be part of lock 82f instead of key 84f, for example see indicator 160f in FIG. 23.

In some cases it may be desirable to place an additional disassembly sensor 264f in key 84f. Referring again to FIGS. 19 and 20, one version of this is to place contacts 242f and 243f at the bottom of shaft 134f that make contact with a conductive plate 244f located within the recess formed by bottom section 104f. Attempts to disassemble lock 82f when key 84f is in the lock can be detected by sensor 264f no longer presenting a closed circuit to processor 250f when removal sensor 254f indicates key 84f is still in lock 82f. When this happens, processor 250f may delete the secret message.

While conductors 236f are shown placed between a recession 128f and a raised member 129f of tumbler 114f, the conductors can be placed elsewhere and no ratchet mechanism need be provided. Furthermore it is anticipated that other sensors can be used by key 84f to determine when tumblers 114f have be placed in the unlocked position (e.g. by using a sensor along key 84f for each tumbler 114f). The sensors need not use contacts and, instead, can be magnetic, optical, or other non-contact sensors.

It is also anticipated that other type of sensing technology can be used for removal sensor 254f, alignment sensor 256f, and disassembly sensor 264f other than electrically conductive sensors. Other sensors include, without limitation, optics, fiber optics, buttons, switches, resistors, capacitors, and magnets.

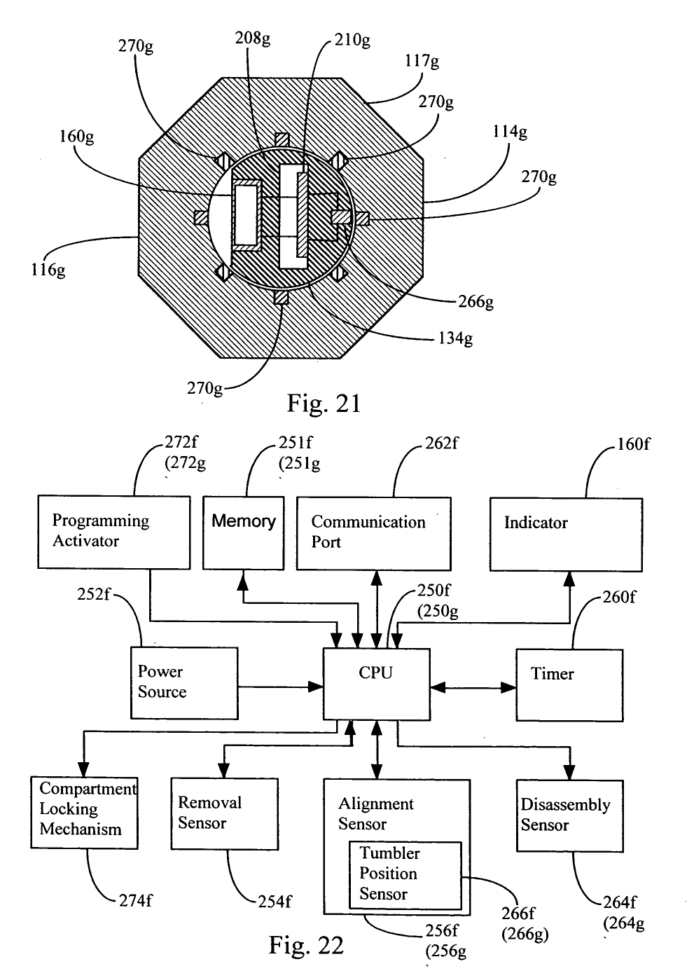

As in the case of the mechanical Cryptex assemblies described above, in some cases it may be desirable to alter a Cryptex answer words. Referring now to FIG. 21, an exemplary alternate electronic tumbler and key configuration 80g includes a separate tumbler position sensor 266g for each tumbler where each tumbler 114g includes a separate resistor 270g for each separate mark or indicia 116f on external surface 117g. Each of the resistors 270g has a resistance value that is unique to the specific tumbler 114g and is aligned so that when an associated indicia or mark on surface 117g is aligned with one of the alignment markers (see again 113 in FIG. 1), sensor 266g can sense the resistance value and hence processor 250f can identify the position of the tumbler 114g.

When key 84g is in channel 360g processor 250g is placed in a programming mode by programming activator 272g which may be an external button or a radio receiver. When the programming activator is activated (e.g., pressing a button or receiving a programming radio signal), processor 250g senses the resistance value for each tumbler 114f using tumbler position sensor 266g and places the value in memory 251g. During subsequent use, processor 250g determines that lock 82g is unlocked when the same resistance values are measured for each tumbler 114g as stored in memory 251g and sets the unlock flag. Any other resistance values correspond to a locked position.

Tumbler position sensor 266g can sense other physical traits beside resistance, for example capacitance or reflected light color.

When the resistance values corresponding to each indicia 16g are known, processor 250g can be programmed when key 84g is not in lock 82g . Programming activator 272g may include communication port 272g in the form of a linking device or connector (e.g., a USB connector) linked to processor 250g or via a radio frequency link (e.g. Bluetooth or 802.11b). Communication port 272g receives a programming signal from an external computer using a second linking device (e.g., a matching USB connector or radio frequency link) with the resistance values for each tumbler 114g and sends it to processor 250g to store in memory 251g. In this manner the sequence of markings that are used to unlock lock 82f can readily be provided by external programming as discussed in additional detail below.

Referring again to FIGS. 19, 20 and 22, where an electronic version of the Cryptex 80f includes a compartment (e.g., 164 in previous embodiments), processor 250f can also be linked to a compartment locking mechanism 274f which is used to secure or block access to the compartment. Processor 250f releases compartment lock 274f when lock 82f is unlocked and key 84f is removed and allows access to the compartment so any object, message or gift can be removed. When key 84f is removed and lock 82f is in a locked position, compartment lock 274f is used to secure the compartment. Compartment lock 274f can be used instead of indicator 160f or with indicator 160f.

Compartment lock 274f can follow the same rules described above for activating indicator 160f. That is, if key 84f is removed when lock 82f is locked, compartment lock 274f can remain secured for a period of time (e.g. 1 hour) before it can be attempted to be unlocked again. When key 84f is removed and lock 82f is in the unlocked position, compartment lock 274f may be deactivated allowing access to the compartment. In some cases, compartment lock 274f is arranged to prevent key 84f from being removed from lock 82f until tumblers 114f are in the unlocked position.

Cryptex 80f can also provide additional hints, clue(s), or word puzzles to assist in discovering the answer word. A clue can either be a new word puzzle or can be a descriptor of the answer word (e.g. “it starts with a S”, “it isn't a rock”). Clues can be presented using indicator 160f when the indicator is visible or audible outside of Cryptex 80f. For example, the word puzzles can be presented over a period of time or vary by the number of attempted removals of key 84f from lock 82f.

Referring again to FIG. 21, where a Cryptex answer word can be altered electronically, it is possible to use the Cryptex 80g to play more complicated multi-answer games where a recipient must answer multiple word puzzles, each with a separate answer word, to gain access to a compartment or to have a message presented. In this case, the answer words may be stored in a key memory and Cryptex 80g must be unlocked by rotating tumblers 114g to a specific alignment orientation with the alignment markers so that indicia 116g spell each answer word in succession. Presumably, each word puzzle is presented to the user in succession, (e.g., as a series or cards sent or provided over time).

Word puzzles can also be stored in a key memory and can be presented using an externally mounted indicator where the process of presenting word puzzles can be understood by a person who has not unlocked the Cryptex or removed the key. This can be done by using a display 160h that is mounted on the exterior of a Cryptex as seen in FIG. 23 or by using a speaker that can be heard outside of the Cryptex. When desired, more than one indicator can be provided. For each word puzzle, additional clues can be stored in the key memory and provided should additional assistance be required to discover the corresponding answer word.

Cryptex Purchasing

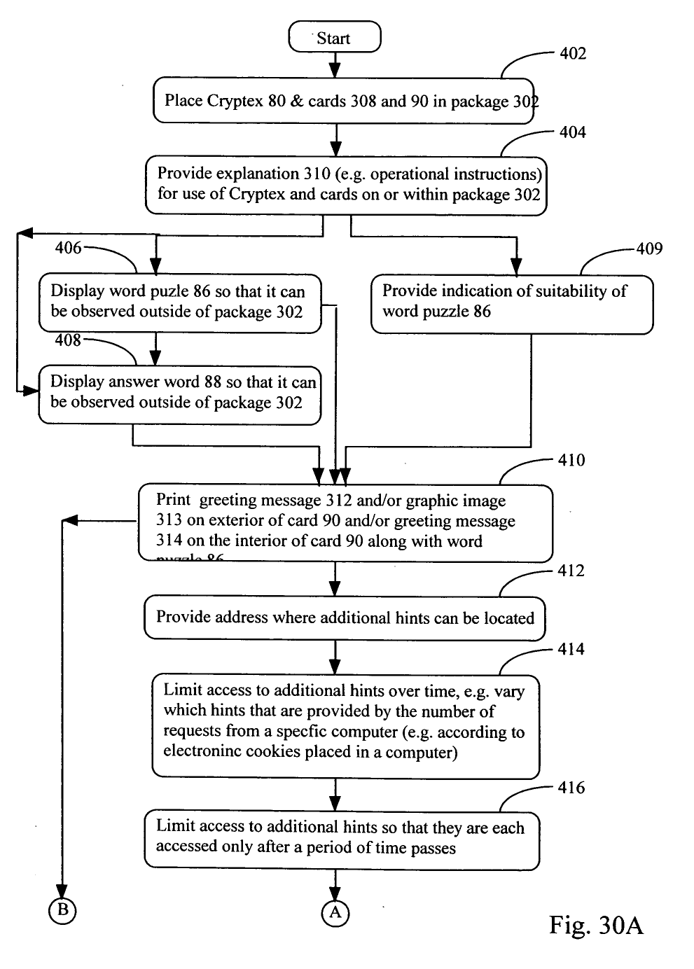

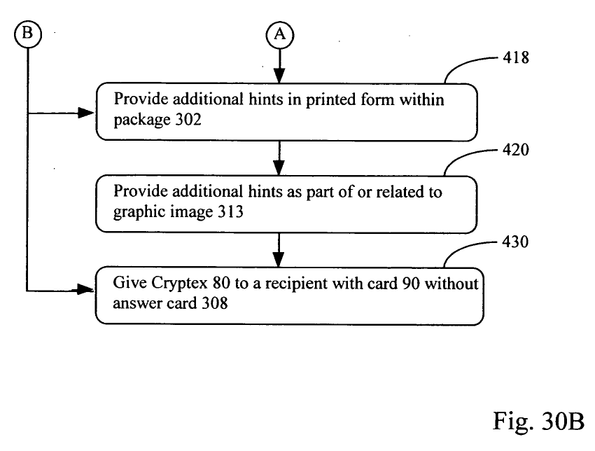

Exemplary methods for selling and using Cryptex are illustrated in FIGS. 30A-34B that are consistent with at least some aspects of the present invention. It is anticipated that one particularly useful way to sell Cryptex will be at a store as part of a novelty item or gift set 300. To this end, an exemplary gift set 300 is illustrated in FIG. 23 and an exemplary way of selling is illustrated in FIGS. 30A-30B. Set 300 includes a box 302, a card 90, a Cryptex 80 and a second card 308. Here, it is contemplated that cards 90 and 308 and Cryptex 80 will, in at least some cases, be placed within box 302 for sale (Step 402). The exterior of box 302 may be printed with an explanation 310 which explains the operation and purpose of gift set 300 (Step 404). The exterior may also include a display of word puzzle 86 corresponding to the associated Cryptex 80 (Step 406) so a purchaser can determine if the word puzzle 86 is one they or an intended recipient will like. In some cases the word puzzle 86 is not displayed and the purchaser may have to rely on other indications as to the suitability of the puzzle question for the intended recipient (e.g., a difficulty level or a general identifier of the subject matter related to the word puzzle 86 (Step 409) in which case Step 406 can be skipped). Answer word 88 can also be displayed (Step 408), but this is not required. Where answer word 88 is presented, the presentation will give a purchaser a clear idea how difficult it might be to solve the word puzzle 86 and appropriateness of giving the Cryptex 80 to a specific recipient.

Greeting card 90 can have a printed exterior greeting message 312 and/or graphic image 313 and/or an interior greeting message 314 (Step 410) as well as the word puzzle 86. When desired, card 90 will also include an Internet address 316 (e.g., printed on the back of card 90) where additional clues, hints or puzzle questions can be found related to answer word 88 for the specific Cryptex 80 (Step 412). This can be of great help when the recipient cannot solve the word puzzle 86 question and unlock Cryptex 80. The additional clues or hints can be provided as a single web page or as a series of hints that change over time (Step 414) so that more assistance is available but not all at once. This can also be done by changing the hint each time the person uses a browser to get a hint by using a cookie to determine the number and time of visits. Furthermore, a timer may be used to prevent the person from getting all of the hints too quickly (e.g., one per day) (Step 416). Additional hints can be printed and provided in box 302 (Step 418) and given to the recipient over time at the discretion of the purchaser/giver. Graphic image 313 can also relate to word puzzle 86 and answer word 88 (Step 420). For example, in some cases, answer word 88 can be an object either in or in some cases missing from image 313.

When Cryptex 80 and card 90 are given to a recipient, the purchaser/giver retains the printed answer card 308 (Step 430). In some cases, printed answer card 308 is not provided and answer word 88 is not printed on box 302. In this case, Cryptex 80 is unlocked only via solving word puzzle 86, with or without Internet provided hints.

While set 300 includes box 302, it is anticipated that set 300 may not include box 302. For example, a blister pack, bag, or other means may be provided to keep Cryptex 80, greeting card 90 and printed answer card 308 (when provided) from being separated before purchase.

Furthermore, answer word 88 need not be provided. In this case the purchaser is unaware of the answer. Typically, in this case, retainer 160 will be preloaded (e.g. prior to purchase) with an object, item, or a hidden message. In some cases the item may be a gift certificate or discount coupon in other cases it is an item specified by the purchaser, for example when Cryptex 80 is customized as part of its purchase as when using the Internet, (e.g. as part of a recognition program employers may purchase a Cryptex with a preloaded check or gift certificate for employees who are granted patents and specify answer word 88 to be the number of the issued patent). In this case no word puzzle 86 need to be given to the employee, but typically a congratulatory greeting card 90 is provided.

Cryptex 80, when equipped with tumblers 114 that allow the alignment of keyway 124 to be changed, can also be purchased without the remaining parts of set 300. In this case, referring to FIG. 31, the purchaser will provide a greeting card of their own, for example, with the word puzzle 86 created and printed by the purchaser and the answer word 88 being a secret to the purchaser (Step 440). By modifying the alignment of keyways 124 in tumblers 114 (Step 442), Cryptex 80 can be unlocked using the purchaser's self chosen answer word 88 (Step 444). As previously described, Cryptex 80 can have one or more lower tumblers 114 restrained to accommodate short answer words 88 or tumblers can be added or removed from lock 82 and segments 195 to key 84 to accommodate answer words of various lengths.

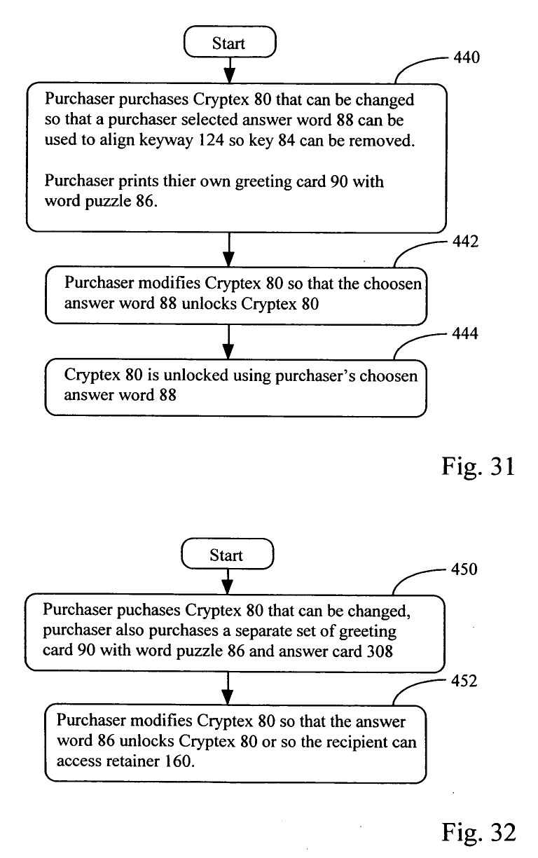

In other cases where Cryptex 80 can be modified by a purchaser to accommodate different answer words 88, referring to FIG. 32, greeting card 90 with printed word puzzle 86 and matching printed answer card 308 can be purchased together, but separate from Cryptex 80 (Step 450). The purchaser then rearranges keyways 124 so that when external indicia 116 match the answer word 88, key 84 can be removed from lock 82 (Step 452).

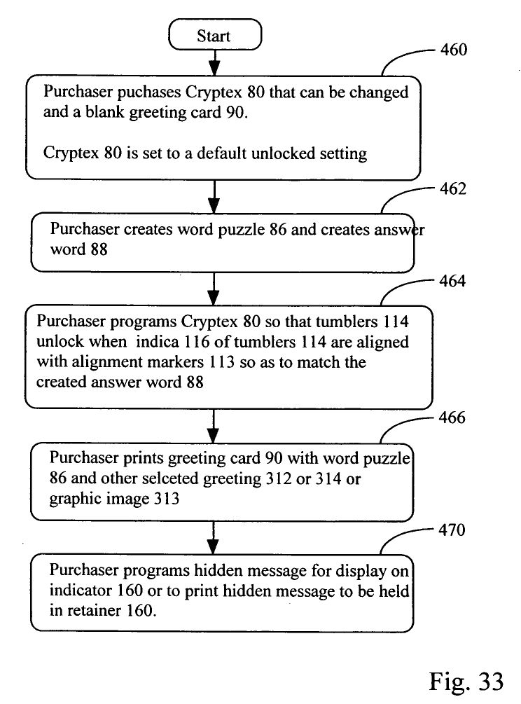

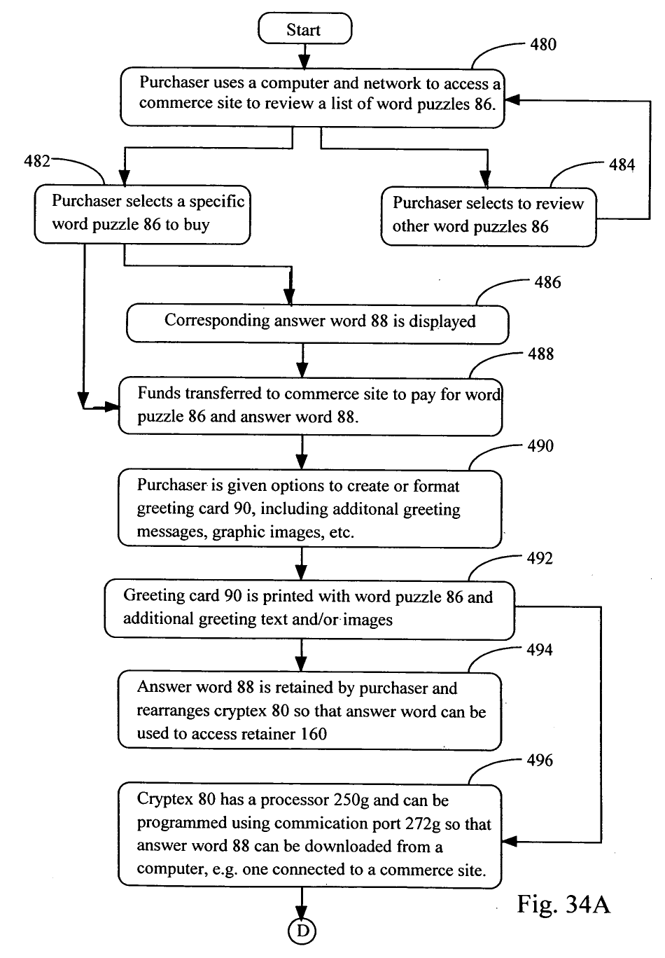

In some cases, set 300 is comprised only of Cryptex 80, which can be reprogrammed, and greeting card 90, which is blank or at least without word puzzle 86. In this case, referring to FIG. 33, lock 82 and key 84 may be separated or the markings or indicia 116 lined up to a default unlocked setting (e.g., all “A” characters) (step 460). The purchaser creates their own word puzzle 86 and answer word 88 (Step 462). At step 464, the purchaser programs the crypts 80 so that the tumblers 114 unlock when indicia 116 of the tumblers 114 are aligned with alignment markers 113 so as to form the answer word. The user uses a retail self service station or kiosk or their own computer with a user interface or display 320, a selection indicator (e.g. a mouse, keyboard, or voice recognizer) and a printer to print a word puzzle 86 and any other greeting or image 313 on card 90 (Step 466). The computer can also be used to program a hidden message via a processor to be displayed via an indicator or to print out the hidden message that will be held in retainer 160 (Step 470). The retailer kiosk can also provide the user with choices of greeting messages 312 or 314 and images 313.

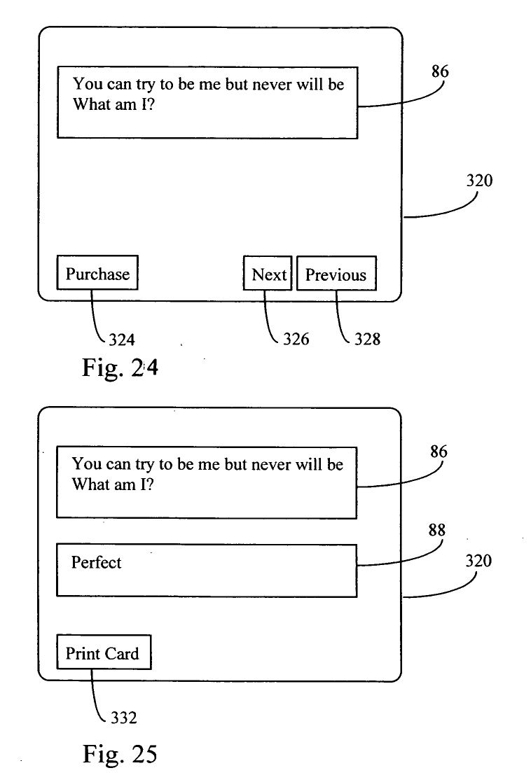

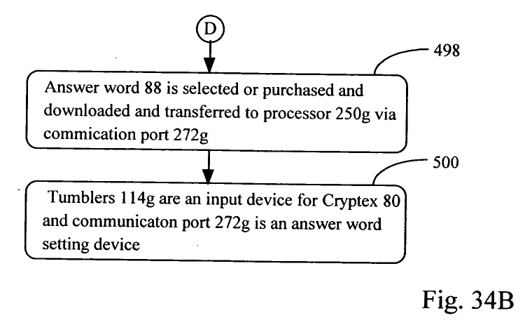

It is possible to purchase greeting card 90 or word puzzle 86 via an Internet commerce site. In this regard, see FIGS. 34A-34B. The site can display a list of word puzzles 86 on a computer interface or display 320 as shown in FIGS. 24 and 25 (Step 480). The purchaser can select to purchase (by selecting button 324 with a computer pointing device) word puzzle 86 as part of a greeting card 90 (Step 482) or go to the next (by selecting button 326) or previous (button 328) word puzzle choices (Step 484). Once selected for purchase, the corresponding answer word 88 can be displayed (Step 486) and appropriate funds are transferred to the selling Internet commerce site (Step 488). The purchaser can be provided with additional selections to customize greeting card 90 with additional information (e.g., a specific message, greeting, and name(s)) (Step 490). By selecting print button 332, the greeting card 90 with any customized messages and the selected word puzzle 86 is printed (Step 492). The purchaser retains the answer word 88 and rearranges keyways 124 so that the answer word 88 will unlock lock 82 (Step 494). When Cryptex 80 includes a processor (see 250g in FIG. 21), separate tumbler position sensors 268g, and a communication port 272g , the arrangement of the indicia 116g on the tumblers 114g that unlock lock 82g can be downloaded or received from an Internet connected computer (Step 496). This allows the answer word to be selected or purchased and downloaded for transmission to processor 250g for storage by communication port 272g (e.g. a USB connector or radio frequency link) (Step 498). This can be done without displaying or disclosing answer word 88 to the purchaser so that they can challenge themselves to solve word puzzle 86.

In this case tumblers 114g can be considered to be an input device and communication port 272g can be considered an answer word setting device when used with an external computer and interface 320g (Step 500).

It is also possible to let the user select the answer word 88 first for purchase and then display an associated word puzzle 86. In this case, steps 480 to 488 are repeated substituting answer word 88 for word puzzle 86 and visa versa. Here, each of the answer word and word puzzle can be considered puzzle components, but only one is displayed prior to purchasing the other. In either case, the purchaser is not shown both word puzzle 86 and answer word 88 prior to purchasing the combination.

It is anticipated that indicia 116, instead of being fixed or printed on tumbler 114, can be varied, e.g. by using processor 250f to control LCD's, digital ink, or other displays technologies to dynamically present indicia 116 depending on the downloaded answer word 88. In this case no alteration of the tumblers needs to be made by the purchaser to accommodate any word where the character count is less or equal to the number of tumblers 114 of Cryptex 80.

Varying Tumbler Arrangement for a Specific Answer Word

When individual tumblers can be added or removed, when tumblers can be restrained from rotating (e.g. using pin 190), or a tumbler is composed of an external member and an internal member, instructions can be provided to assist in modifying a Cryptex 80 based on a specific answer word that is selected. For example, referring again to FIGS. 7-10, outer external member 170b can be provided in a ten sided format with 10 letters. In this case, the 26 characters of the alphabet plus the space character can be deployed on three different tumblers 114b. For example one tumbler 114b may have the 10 least used letters of the English language appearing on it, while the other two would have the remaining letters. By providing only one tumbler 114b with the least used letters and a small selection of the other tumblers (e.g. three of each of the other tumblers), almost any seven letter answer word can be created with a Cryptex.

To modify the Cryptex answer word, a specific answer word is selected (e.g., at a retailer Kiosk or using an internet browser). Software then determines an arrangement of the external member 170b versus the internal member 172b for each tumbler 114b, so that when the tumblers 114b are arranged with the answer word aligned with alignment marks 113b, the Cryptex is unlocked. This can be aided by placing a different numeric designation on each or the four different tumblers 114b. The instructions can then indicate that the tumblers are to be stacked in an order corresponding to tumbler numeric designations 3, 2, 2,1, 1, 2, 1.

As a further aid, external member 170b can have a numeric designation imprinted on its top surface 118b corresponding to each indicia 116b. By further designating this number, an inner piece can be rotated or positioned so that keyway 124b is aligned with a specific one of the numbers on the external member and hence with a specific one of the letters. The instructions to configure a Cryptex 80b that unlocks using a selected answer word would then appear as instructions to arrange external members 170 and internal members 172 in the following order. 3-5, 2-7, 2-1, 44, 1-6, 2-8, 1-4, where the first number indicates one of the three different tumbler types and the second number in each pair indicates how the inner and outer members should be aligned.

Other marking techniques are contemplated, for example selling multiple different tumblers 114 each with a different letter of the alphabet aligned with keyway 124. To change the answer word 88 tumblers 114 are purchased corresponding to the selected answer word.

In some cases the instructions may include information to pin or restrain a specific tumbler so that it cannot rotate. In other cases the instructions may indicate specific tumblers that should be purchased to build a Cryptex 80 that unlocks using a specific answer word. Purchasing of additional tumblers may be essential when tumblers are not composed of external members and internal members or otherwise adjustable.

In some cases, tumblers 114 are selected so that, when arranged in a specified order, they can be aligned with alignment marker 113 to spell a large variety of English or other words even if the words are not the specific answer word that could unlock the assembly. In some cases the words are selected so they could also be possible, but not perfect or intended, solutions to an associated word puzzle.

While the invention may be susceptible to various modifications and alternative forms, specific embodiments have been shown by way of example in the drawings and have been described in detail herein. However, it should be understood that the invention is not intended to be limited to the particular forms disclosed. For example, in some cases alignment pin 154 and hole 157 may not be required. In addition, in some cases marks 113 may not be provided.

In at least some cases it is contemplated that when a cryptex is packaged for sale, a specific item may be placed in the cryptex that cannot be accessed without first manipulating the cryptex to spell an answer word. For instance, a toy may be placed in the cryptex to be discovered by a child when the cryptex is open. Here, in at least some cases it is contemplated that when the cryptex is sold, the cryptex packaging or the like may be provided with information specifying the contents of the cryptex (e.g., in the present case, that a toy of a particular nature is inside the cryptex).

In other cases it is contemplated that, in the context of a cryptex that is purchased over a computer network or via a kiosk, the cryptex may not be provided until some type of fund transfer occurs and a system may be provided to facilitate such fund transfer. For instance, in a case where a cryptex is purchased over the internet, after indicating that the cryptex is to be purchased, credit card information would be obtained from the purchaser prior to cryptex shipment.

Thus, the invention is to cover all modifications, equivalents, and alternatives falling within the spirit and scope of the invention as defined by the following appended claims.

To apprise the public of the scope of this invention, the following claims are made:

1. A method for selling novelty items, the method including the steps of:
providing an apparatus including a retainer and an input device, the retainer for concealing at least one of a message and an item until a specified word that is specified via the input device matches an answer word;
providing a first card including a word puzzle that can be answered with the answer word; and
presenting the card and apparatus together as a set for sale.

2. The method of claim 1 wherein the step of presenting includes placing the apparatus within a package and printing the answer word on a member that is observable from outside the package.

3. The method of claim 2 wherein the step of presenting also includes presenting a network address that is accessible via a computing device to obtain hints to determine the answer word.

4. The method of claim 3 further including the step of varying the hints over time that are obtainable at the address.

5. The method of claim 3 wherein the step of presenting a network address includes printing the network address on a member and placing the member within the package.

6. The method of claim 2 wherein the step of printing includes printing the answer word on at least one of an external surface of the package, a tag linked to the package, a second card associated with the package and a paper insert included with the package.

7. The method of claim 2 wherein the step of presenting further includes placing the first card within the package so that the word puzzle is hidden.

8. The method of claim 2 wherein the step of presenting further includes printing the word puzzle on a member that is observable from outside the package.

9. The method of claim 1 wherein the step of presenting includes placing the apparatus within a package and printing the word puzzle on a member that is observable from outside the package.

10. The method of claim 9 wherein the step of presenting further includes placing the answer word within the package so that the answer word is hidden.

11. The method of claim 1 wherein the step of presenting also includes presenting a network address that is accessible via a computing device to obtain hints to determine the answer word.

12. The method of claim 11 further including the step of varying the hints over time that are obtainable at the address.

13. The method of claim 1 wherein the step of presenting further includes placing the first card within the package so that the word puzzle is hidden.

14. A method for selling novelty items, the method including the steps of:
providing an apparatus including a retainer, an input device and a word setting device, the word setting device for setting an answer word associated with the apparatus, the retainer for concealing at least one of a message and an item until a specified word specified by the input device matches the answer word set by the word setting device;
providing a list of word puzzles via a computer interface, each word puzzle associated with an answer;
receiving a selection indication selecting one of the word puzzles;
rendering the word puzzle accessible by a recipient;
using the word setting device to set the answer word to the answer; and
presenting the apparatus to the recipient.

15. The method of claim 14 wherein the step of rendering the word puzzle accessible includes printing the word puzzle on a card, the step of presenting further including presenting the card to the recipient along with the apparatus.

16. The method of claim 14 wherein the step of rendering the word puzzle accessible includes electronically presenting/displaying the word puzzle for accesses by the recipient.

17. The method of claim 14 wherein the step of providing a list of word puzzles via an interface includes providing a kiosk that includes the interface and presenting the list via the kiosk.

18. The method of claim 17 wherein the step of rendering the word puzzle accessible includes printing the word puzzle on a greeting card and presenting the greeting card to the recipient along with the apparatus.

19. The method of claim 14 wherein the step of providing an apparatus including a retainer includes providing an apparatus including a compartment that remains closed until the answer word is specified via the input device.

20. The method of claim 19 wherein the step of providing an apparatus including an input device includes providing an apparatus including a plurality of tumblers that are arranged for rotation about a tumbler axis where each tumbler includes a plurality of characters about an external surface, a subset of the characters alignable along an alignment axis parallel to the tumbler axis to specify the answer word.

21. The method of claim 14 wherein the step of providing an apparatus including a word setting device includes providing an apparatus including a processor and a first linking device where the processor can set the answer word, the step of providing a list of word puzzles via a computer interface including providing the word puzzles via an interface that includes a second linking device, the step of using the word setting device to set the answer word to the answer including using the first and second linking devices to transmit the answer word to the processor and using the processor to set the answer word.

22. The method of claim 14 wherein the step of providing an apparatus including an input device includes providing an apparatus including a plurality of tumblers that are arranged for rotation about a tumbler axis where each tumbler includes a plurality of characters about an external surface, a subset of the characters alignable along an alignment axis parallel to the tumbler axis to specify the answer word.

23. A method for purchasing a word puzzle and an answer word, each of the word puzzle and answer word being a puzzle component, the method comprising the steps of:
providing a payment mechanism for the transfer of funds via an information interface;
presenting a first of the puzzle components via an information interface;
receiving a selection of the first of the puzzle components;
accepting payment for the second of the puzzle components via the payment mechanism; and
presenting the second of the puzzle components via the interface device.

24. The method of claim 23 wherein the step of presenting the first puzzle component includes presenting the word puzzle.

25. The method of claim 23 wherein the step of presenting the first word puzzle component includes presenting the answer word.

26. The method of claim 23 further including the step of formatting the word puzzle for printing on a greeting card.

27. The method of claim 26 further including the steps of presenting additional information that may be included on the greeting card, receiving a selection of at least a sub-set of the additional information to be presented on the greeting card and formatting the additional information along with the word puzzle for presentation on the greeting card.

28. The method of claim 26 further including the step of printing the greeting card.

29. The method of claim 23 further including the steps of providing a apparatus including a retainer, an input device and a word setting device, the word setting device for setting an answer word associated with the apparatus, the retainer for concealing at least one of a message and an item until a specified word specified via the input device matches the answer word set by the word setting device, using the word setting device to set the answer word to the answer, presenting the apparatus to a recipient and rendering the word puzzle accessible to the recipient.

30. The method of claim 23 further including the steps of ordering a apparatus including a retainer and an input device, the retainer for concealing at least one of a message and an item until the answer associated with the word puzzle is specified by the input device, delivering the apparatus to a recipient and rendering the word puzzle accessible to the recipient.

31. The method of claim 30 further including the step of specifying the contents of the retainer and before the step of delivering the apparatus to a recipient including the specified contents of the retainer in the retainer.

32. A method for use with a apparatus including a retainer, an input device and a processor, the retainer for concealing at least one of a message and an item until a specific answer word associated with the processor is specified by the input device, the method comprising the steps of:
linking the processor to a server via a computer network;
transmitting an answer word to the processor via the network;
associating the transmitted word with the processor;
presenting the apparatus to a recipient; and
rendering a word puzzle that can be answered with the answer word accessible to the recipient.

33. A method for selling novelty items, the method including the steps of:
providing an apparatus including a retainer, an input device and a word setting device, the word setting device for setting an answer word associated with the apparatus, the retainer for concealing at least one of a message and an item until a specified word specified by the input device matches the answer word set by the word setting device;
providing a list of word answers via a computer interface, each word answer associated with a word puzzle;
receiving a selection indication selecting one of the word answers;
rendering the word puzzle associated with the selected word answer accessible by a recipient;
using the word setting device to set the answer word to the answer; and
presenting the apparatus to the recipient.

34. The method of claim 33 wherein the step of rendering the word puzzle accessible includes printing the word puzzle on a card, the step of presenting further including presenting the card to the recipient along with the apparatus.

35. The method of claim 33 wherein the step of rendering the word puzzle accessible includes electronically presenting/displaying the word puzzle for access by the recipient.

36. The method of claim 33 wherein the step of providing a list of answer words via an interface includes providing a kiosk that includes the interface and presenting the list via the kiosk.

37. The method of claim 36 wherein the step of rendering the word puzzle accessible includes printing the word puzzle on a greeting card and presenting the greeting card to the recipient along with the apparatus.

38. The method of claim 33 wherein the step of providing an apparatus including a retainer includes providing an apparatus including a compartment that remains closed until the answer word is specified via the input device.

39. The method of claim 38 wherein the step of providing an apparatus including an input device includes providing an apparatus including a plurality of tumblers that are arranged for rotation about a tumbler axis where each tumbler includes a plurality of characters about an external surface, a subset of the characters alignable along an alignment axis parallel to the tumbler axis to specify the answer word.

40. The method of claim 33 wherein the step of providing an apparatus including a word setting device includes providing an apparatus including a processor and a first linking device where the processor can set the answer word, the step of providing a list of word puzzles via a computer interface including providing the word puzzles via an interface that includes a second linking device, the step of using the word setting device to set the answer word to the answer including using the first and second linking devices to transmit the answer word to the processor and using the processor to set the answer word.

41. The method of claim 33 wherein the step of providing an apparatus including an input device includes providing an apparatus including a plurality of tumblers that are arranged for rotation about a tumbler axis where each tumbler includes a plurality of characters about an external surface, a subset of the characters alignable along an alignment axis parallel to the tumbler axis to specify the answer word.

42. A method for selling novelty items, the method including the steps of:
providing an apparatus including a retainer, an input device and a word setting device, the word setting device for setting an answer word associated with the apparatus, the retainer for concealing at least one of a message and an item until a specified word specified by the input device matches an answer word set by the word setting device;
receiving an answer word and a message text selected from one of a word puzzle and a greeting message;
modifying the word setting device so that the answer word set thereby is the received answer word;
rendering the message text accessible to a recipient; and
presenting the apparatus to the recipient.

43. The method of claim 42 wherein the step of rendering the message text accessible includes printing the message text on a card, the step of presenting further including presenting the card to the recipient along with the apparatus.

44. The method of claim 42 wherein the step of rendering the message text accessible includes electronically presenting/displaying the message text for access by the recipient.

45. The method of claim 42 wherein the step of receiving the answer word and the message text includes using a computer interface to enter the answer word and message text.

46. The method of claim 45 wherein the step of rendering the message text accessible includes printing the message text on a greeting card and presenting the greeting card to the recipient along with the apparatus.

47. The method of claim 42 wherein the step of providing an apparatus including a retainer includes providing an apparatus including a compartment that remains closed until the answer word is specified via the input device.

48. The method of claim 47 wherein the step of providing an apparatus including an input device includes providing an apparatus including a plurality of tumblers that are arranged for rotation about a tumbler axis where each tumbler includes a plurality of characters about an external surface, a subset of the characters alignable along an alignment axis parallel to the tumbler axis to specify the answer word and the step of modifying the input device includes selecting tumblers corresponding to the answer word.

49. The method of claim 42 wherein the step of providing an apparatus including a modifiable word setting device includes providing an apparatus including a processor and a first linking device where the processor can set the answer word, the step of receiving the answer word includes entering the answer word using an interface linked to a second interface device, and the step of modifying the word setting device so the answer word is the received answer word includes using the first and second linking devices to transmit the answer word to the processor and using the processor to set the answer word.

50. The method of claim 42 wherein the step of providing an apparatus including an input device includes providing an apparatus including a plurality of tumblers that are arranged for rotation about a tumbler axis where each tumbler includes a plurality of characters about an external surface, a subset of the characters alignable along an alignment axis parallel to the tumbler axis to specify the answer word.

51. The method of claim 42 wherein the step of providing the apparatus includes receiving a designation of the contents of the retainer and providing the designated contents in the retainer.

52. The method of claim 51 wherein the step of providing the apparatus includes the steps of providing a cost for providing the apparatus and receiving a payment prior to providing the apparatus.

53. A method for selling novelty items, the method including the steps of:
providing an apparatus including a retainer and a modifiable input device, the retainer for concealing at least one of a message and an item until a specified word specified by the input device matches a designated word;
receiving an answer word and a message text selected from one of a word puzzle and a greeting message;
modifying the input device so that the designated word is the received answer word;
rendering the message text accessible by a recipient; and
presenting the apparatus to the recipient word.

54. The method of claim 53 wherein the input device includes a plurality of tumblers that are arranged for rotation about a tumbler axis where each tumbler includes a plurality of characters about an external surface, a subset of the characters alignable along an alignment axis parallel to the tumbler axis to specify answer words word.

55. The method of claim 54 wherein the step of modifying includes selecting tumblers as a function of the letters in the answer word and assembling the selected tumblers so as to form the answer word when the tumblers are properly aligned.
